(19) United States
(12) Patent Application Publication
(10) Pub. No.: US 2012/0126643 A1
(43) Pub. Date: May 24, 2012

(54) APPARATUSES USEFUL FOR COOLING WINDINGS OF ROTOR ASSEMBLIES

(76) Inventor: Ping Zhong, Austin, TX (US)

(21) Appl. No.: 12/950,016

(22) Filed: Nov. 19, 2010

(51) Int. Cl. H02K 3/38

(52) U.S. Cl. 310/59

(57) ABSTRACT

Braces that can be placed in the gap between adjacent rotor field windings to help secure the rotor field windings in place during operation and that help cool those windings. Rotor assemblies with cooling ducts, such as rotor body cooling ducts and pole body cooling ducts, that help cool rotor field windings.

### BACKGROUND OF THE INVENTION

1. Field of the Invention

The invention relates generally to the field of rotating machines, such as motors and generators. More particularly, it relates to apparatuses that are useful for cooling the windings of the rotor assemblies of such machines, especially salient pole synchronous motors or generators, and the resulting rotor assemblies.

2. Description of Related Art

The problem with keeping windings of rotor assemblies cool during operation is well known. If the windings are not kept sufficiently cool, the machine of which the rotor assembly is a part will not function properly. One manner of addressing the problem is to reduce the current flowing through the windings. The corresponding power output reduction may, however, render the machine incompatible with a given application. Alternatively, steps can be taken to cool the windings so that the winding current need not be reduced. U.S. Pat. Nos. 3,660,702 and 4,358,698, both of which are incorporated by reference, discuss the problem of keeping windings on rotor assemblies cool and recount certain ways of addressing the problem.

Turning specifically to synchronous motors and generators with salient pole designs, determination of the rotor size—and hence the stator size—is influenced by the cooling performance of the windings (sometimes termed “rotor field windings”). A larger diameter rotor and a lower rotor field winding current density are usually chosen when thermal limitations exist that cannot be overcome.

Both convection and conduction have been used to cool the windings of such machines. For example, convection has occurred between an external cooling gas (e.g., air) and the outside of a given winding (e.g., the part of the winding left exposed when the pole tip is in place). The cooling effect of conduction between the rotor and the inside of a given winding (e.g., the portion facing the pole body it surrounds) has generally been limited due to poor contact between the inside and the pole body, and poor heat conduction coefficients of stagnant air and the various insulation layers of the winding.

Furthermore, some braces that have been used to help hold the windings in place can block or reduce the external cooling gas from traveling the length of the pole body in the axial direction in order to cool the outside of the winding. In such cases, the central part of the winding enjoys less heat transfer by convection from the winding outside to the external cooling gas.

### SUMMARY OF THE INVENTION

The present apparatuses can be used alone or in any combination with each other to cool one or more windings of rotor assemblies. The rotor assemblies may be part of rotating machines such as motors and generators, including synchronous motors or generators having salient pole designs.

One embodiment of the present apparatuses comprises a brace that includes a first side configured to contact a first winding of a rotor assembly; a second side configured to contact a second winding of a rotor assembly; a third side oriented at an angle to the first and second sides; and first and second openings positioned in the third side. In this embodiment, a plane that does not intersect either winding is positioned between the first and second sides, the first opening is positioned on one side of the plane, and the second opening is positioned on another side of the plane. Other embodiments of the present apparatuses that involve such a brace are described below.

Another embodiment of the present apparatuses comprises a brace that includes a first side configured to contact a first winding of a rotor assembly having a rotation axis; a second side configured to contact a second winding of the rotor assembly; a segment positioned between the first and second sides; and a blade lying in a plane that intersects the segment but not the first side or the second side. Other embodiments of the present apparatuses that involve such a brace are described below.

Another embodiment of the present apparatuses comprises a rotor assembly that includes a rotor body having a rotation axis; a non-laminated pole body extending from the rotor body, the non-laminated pole body having a first side in which a recess is positioned; and a winding positioned around the non-laminated pole body. In this embodiment, a pole body cooling duct is formed by at least the recess and the winding. Other embodiments of the present apparatuses that involve such a rotor assembly (and, therefore, such a pole body cooling duct) are described below.

Another embodiment of the present apparatuses comprises a rotor assembly that includes a rotor body having a rotation axis; a pole body extending from the rotor body, the pole body having a first side in which a recess is positioned, the first side being substantially parallel to the rotation axis; and a winding positioned around the pole body. In this embodiment, a pole body cooling duct is formed by at least the recess and the winding. Other embodiments of the present apparatuses that involve such a rotor assembly (and, therefore, such a pole body cooling duct) are described below.

Another embodiment of the present apparatuses comprises a rotor assembly that includes a rotor body having a rotation axis; a non-laminated pole body extending from the rotor body, the non-laminated pole body having a first side that is substantially perpendicular to the rotation axis; a winding positioned around the non-laminated pole body, the winding having a first end section that is substantially perpendicular to the rotation axis, the first end section having an inside, the inside and the first side of the non-laminated pole body bordering a space; and a pole tip connected to the non-laminated pole body, the pole tip having a passageway in fluid communication with space. Other embodiments of the present apparatuses that involve such a rotor assembly (and, therefore, such a space/rotor body cooling duct combination) are described below.

Another embodiment of the present apparatuses comprises a fan system configured to be connected to a rotor body. The fan system includes an inner mounting ring; a middle ring having an inside and an outside a middle ring width, the middle ring being spaced apart from the inner mounting ring; an outer ring spaced apart from the middle ring and having an outer ring width; inner fan blades positioned nearer the inside than the outside; and outer fan blades positioned nearer the outside than the inside. Other embodiments of the present apparatuses that involve such a fan system are described below.

Some embodiments of the present methods include directing air, such as with a fan (e.g., an axial fan) through braces in contact with pole bodies of a rotor assembly and through passageways in the rotor body that are in communication with passageways defined by the windings and the pole bodies and other passageways provided in the pole tips.

Any embodiment of any of the present apparatuses, devices, and methods can consist of or consist essentially of—rather than comprise/include/contain/have—any of the described elements and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. The use of identical reference numerals does not necessarily indicate an identical structure. Rather, the same reference numeral may be used to indicate a similar feature or a feature with similar functionality. For clarity, not every feature is labeled in every figure. The structures shown in the figures are drawn to scale, unless otherwise noted.

FIG. 1 is a front view of one of the present openings braces (the back view being identical), which is one of the present apparatuses.

FIGS. 2A-2C are top, side, and bottom views, respectively, of the openings brace depicted in FIG. 1.

FIG. 3 is a partial perspective view of one of the present apparatuses, showing certain of the present openings braces bolted to one of the present rotor bodies.

FIG. 4 is a perspective view of one of the present blade braces, which is one of the present apparatuses.

FIG. 5A is a top view of the blade brace depicted in FIG. 4.

FIG. 5B is a bottom view of the blade brace depicted in FIG. 4.

FIG. 6A is a front view of the blade brace depicted in FIG. 4 (the back view being identical).

FIG. 6B is a side view of the blade brace depicted in FIG. 4 (the other side being identical).

FIG. 7 is a top view of one of the present pole bodies in cross section, the pole body having certain of the present recesses in two of its sides.

FIG. 8 shows a winding positioned around the pole body depicted in FIG. 12.

FIG. 9 shows the pole tip that is integral with the pole body depicted in FIG. 12.

FIG. 10 is a perspective view of one of the present poles.

FIG. 11 is a top view of the pole depicted in FIG. 10.

FIG. 12A is a bottom view of the pole depicted in FIG. 10.

FIG. 12B is a side view of the pole depicted in FIG. 10.

FIG. 12C is an end view of the pole depicted in FIG. 10.

FIG. 12D is a cross-sectional view of the pole depicted in FIG. 10, taken along line A-A in FIG. 11.

FIG. 12E is a cross-sectional view of the pole depicted in FIG. 10, taken along line B-B in FIG. 11.

FIG. 13A is a partial perspective view of one of the present rotor bodies.

FIG. 13B is a front view of the rotor body shown in FIG. 13A. Because the rotor body is symmetrical about its longitudinal axis, this view also represents the back, and, with the exception of groove 177, the top and bottom.

FIG. 13C is a left end view of the rotor body shown in FIG. 13A, the right end view being identical.

FIG. 13D is a partial cross-section view taken along the line shown in FIG. 13C.

FIG. 13E-1 is a partial top view of the rotor body shown in FIG. 13A (and throughout the figures), and FIG. 13E-2 is a partial cross-sectional view taken along the line shown in FIG. 13E-1.

FIG. 13F is a left end view of the rotor body shown in FIG. 13A, where certain passageways are shown in phantom (dashed lines) connecting the rotor body cooling ducts to the exterior surface of the rotor body.

FIG. 13G-1 is a partial top view of the rotor body shown in FIG. 13A, and FIG. 13G-2 is a partial cross-sectional view taken along the line shown in FIG. 13G-1.

FIG. 14 is a partial perspective view showing gas (e.g., air) flow through one of the present rotor assemblies. One of the poles is depicted in exploded fashion.

FIG. 15A is a perspective view of one embodiment of the present rotor assemblies.

FIG. 15B is a view of the left (or exposed) end of the resistance ring shown in FIG. 15A.

FIG. 15C is a side view of the resistance ring shown in FIG. 15A.

FIG. 15D is a view of the right (or non-exposed) end of the resistance ring shown in FIG. 15A.

FIG. 16 is a frontal perspective view of one of the present fan systems.

FIG. 17A is a rear perspective view of the fan system depicted in FIG. 16.

FIG. 17B is an end view of the portion of the fan system depicted in FIG. 16 that will face the rotor assembly shown partially in FIG. 18.

FIG. 17C is a cross-sectional view of the fan system depicted in FIG. 16 taken along the line shown in FIG. 17B.

FIG. 18 is a partial perspective view, showing the fan system depicted in FIG. 16 connected to one of the present rotor bodies.

FIG. 19 is an end view of one of the present rotor assemblies.

FIG. 20 is a partial perspective view showing gas (e.g., air) flow through one of the present rotor assemblies.

FIG. 21 is a perspective view of one of the present rotor assemblies.

### DESCRIPTION OF ILLUSTRATIVE EMBODIMENTS

The terms “comprise” (and any form of comprise, such as “comprises” and “comprising”), “have” (and any form of have, such as “has” and “having”), and “include” (and any form of include, such as “includes” and “including”) are open-ended linking verbs. As a result, a device or method that “comprises,” “has,” or “includes” one or more elements or steps possesses those one or more elements or steps, but is not limited to possessing only those one or more elements or steps. Likewise, an element of a device or a step of a method that “comprises,” “has,” or “includes” one or more features possesses those one or more features, but is not limited to possessing only those one or more features.

Thus, and by way of example, an apparatus “comprising” a brace that includes a first side configured to contact a first winding of a rotor assembly; a second side configured to contact a second winding of a rotor assembly; a third side oriented an angle to the first and second sides; and first and second openings positioned in the third side; where a plane that does not intersect either winding is positioned between the first and second sides, the first opening is positioned on one side of the plane, and the second opening is positioned on another side of the plane, is an apparatus that has, but is not limited to having only, such a brace. That is, the apparatus possesses at least the recited brace, but does not exclude other elements or features that are not expressly recited, such as, for example, a second brace or a rotor body. Likewise, the recited brace may also possess unrecited features, such as a third opening, a fourth side or a hollow portion.

The terms “a” and “an” are defined as one or more than one unless this disclosure explicitly requires otherwise. The terms “first,” “second,” “third,” and the like are used only to make the identification of various features easier, and are not intended to specify an order, importance, or hierarchy of any features.

Openings Braces

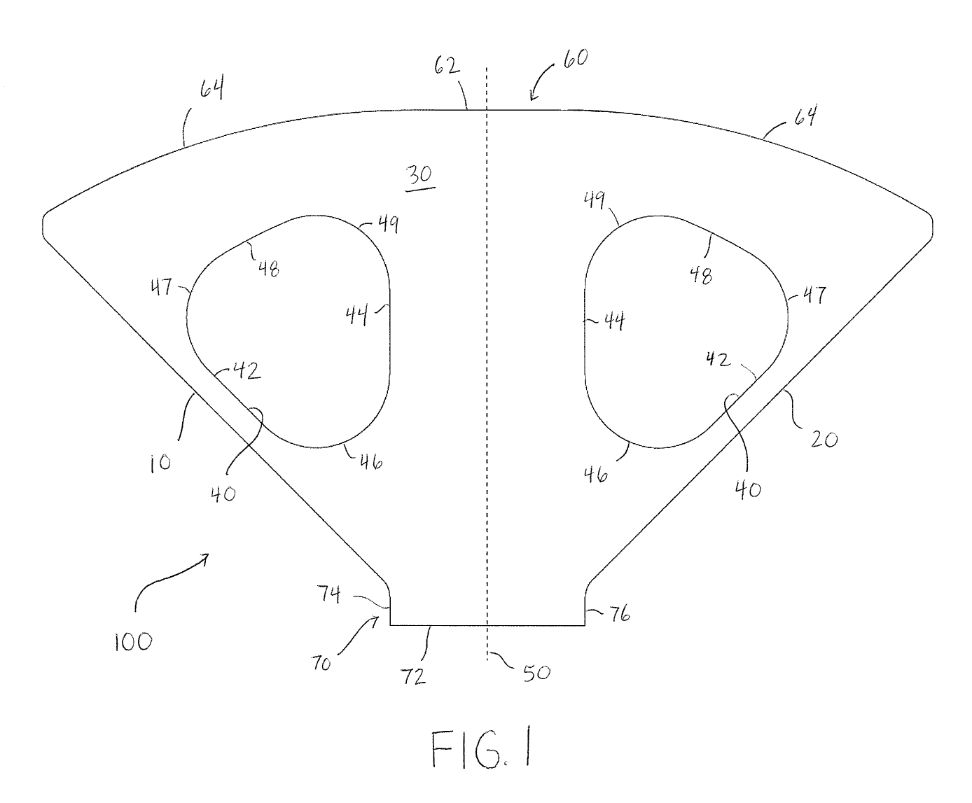

FIG. 1 depicts one embodiment of the present apparatuses that includes one of the present braces (the “openings braces”). Brace 100 is shown from the front and includes a first side 10 that is configured to contact a first winding of a rotor assembly, and a second side 20 that is configured to contact a second winding of the rotor assembly. A side that is “configured to contact a winding” is shaped such that at least a portion of that side will contact at least a portion of the winding—which winding portion may include insulation placed on the material making up the winding—when the brace is connected to the rotor assembly. In this embodiment, both first side 10 and second side 20 are substantially straight. The term “substantially” is defined as being largely but not necessarily wholly what is specified, as understood by a person of ordinary skill in the art. For example, in any of the present embodiments, the term “substantially” may be substituted with “within [a percentage] of” what is specified, where the percentage includes any of 0.1, 1, 5, 10, and/or 15 percent. Brace 100 also includes a third side 30 (e.g., a front or a rear side; they are identical in at least this embodiment) that is oriented at an angle to the first and second sides. “Oriented at an angle” is defined as oriented at a non-zero angle. In this embodiment, third side 30 will be substantially perpendicular to the rotation axis of the rotor body to which brace 100 ultimately is connected.

At least two openings 40 (which may be characterized as first and second openings) are positioned in third side 30. Plane 50 (only the edge of which is visible in this figure) is positioned between first side 10 and second side 20, and is oriented in a way that it will not intersect either the first or the second winding when brace 100 is put into place. As FIG. 1 shows, one opening 40 is positioned on one side (e.g., the left side) of plane 50, and the other opening 40 is positioned on the other side (e.g., the right side) of plane 50. Each opening also may be described as being positioned between plane 50 and either the first or second sides of brace 100. This follows because first side 10 and second side 20 each lie in a plane, and each opening is positioned between plane 50 and one of those additional two planes.

Openings 40 may be identical in shape as shown in FIG. 1. In other embodiments, the openings may have different shapes from each other. One suitable shape of openings 40 is shown in FIG. 1, and includes an outside edge 42 that is substantially straight, an inside edge 44 that is substantially straight, a curved bottom edge 46 that connects outside edge 42 to inside edge 44, a top edge 48 that is substantially straight, an outside upper curved edge 47 that connects outside edge 42 to top edge 48, and an inside upper curved edge 49 that connects inside edge 44 to top edge 48. In other embodiments, different shapes than those shown in FIG. 1 may be used. For example, top edge 48 may not exist, and the two upper curved edges may meet each other.

As shown in FIG. 1, brace 100 also includes a top side 60 that, like third side 30, is oriented at an angle to both first side 10 and second side 20. Top side 60 also is oriented at an angle to third side 30. In the embodiment shown, top side 60 includes a top segment 62 that is substantially straight, and two curved segments 64 that connect top segment 62 to the first and second sides of brace 100. Brace 100 also includes a base 70 that includes a bottom 72 that is configured to contact a rotor body to which brace 100 can be connected, a first base side 74 and a second base side 76. In another embodiment, top side 60 may be straight, and not include curved segments 64. In yet another embodiment, top 60 may have one curve, instead of a flat top segment 62 and two curved segments 64.

In some embodiments, the distance from top segment 62 along a line parallel to plane 50 to bottom 72 is 5.25 inches. Such a brace may be connected to the rotor body of a synchronous motor or generator having a salient pole design, four poles, and a capability of 15,000 HP. (A generator having a “capability” of 15,000 HP has the capacity to generate 15,000 HP; a motor having a “capability” of 15,000 HP has the capacity to deliver 15,000 HP.)

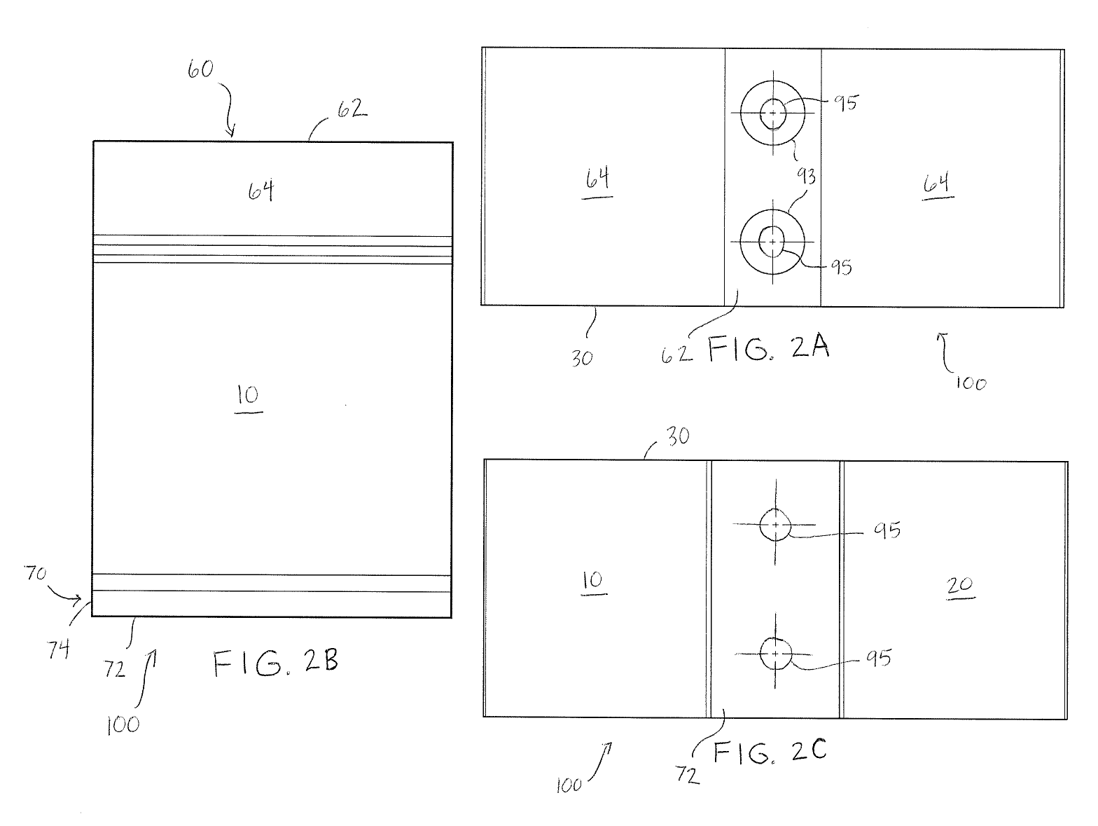

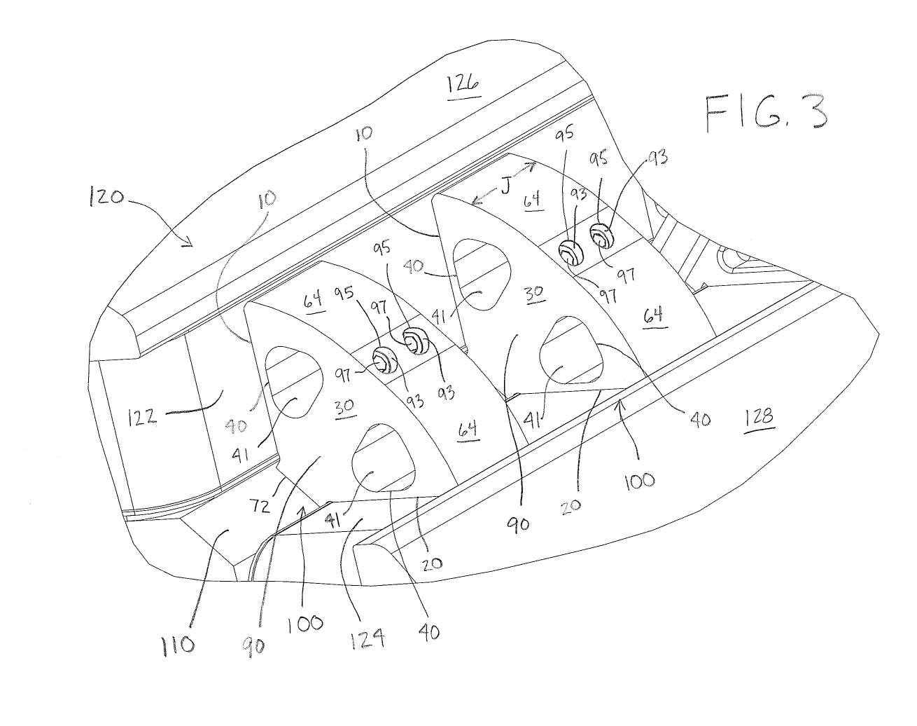

FIGS. 2A-2C show different views of brace 100. FIG. 2A is a top view of brace 100, and shows that brace 100 may be provided with bolt passageways 95 and bolt head recesses 93 positioned at the top of the passageways. The bolt passageways (and bolt head recesses) are not drawn to scale in these figures. Some embodiments of the present braces may be configured with a bolt passageway(s) that has a threaded portion for any suitable length and a bolt head recess that includes a shoulder that will interfere with the head of the bolt, thereby allowing the bolt to connect the brace to the rotor body. Other embodiments of the present braces include no threaded portion and only a bolt head recess that includes a shoulder that will interfere with the head of the bolt, thereby allowing the bolt to connect the brace to the rotor body. Bolts that may be used to connect the present braces to the present rotor bodies include steel SAE J428 grade 8 bolts (e.g., cap screws) or an equivalent or better grade, which may, for example, have the following size: 1″-14 partially threaded socket cap screws that are 8 inches long. Bolt passageways 95 each extend from top segment 62 of the top surface to bottom 72, as shown in FIG. 2C. As FIG. 2A shows, bolt head recesses 93 may have a larger diameter than the remainder of bolt passageways 95 extending beneath them toward bottom 72. FIG. 2B is a left side view of the brace, the right side view being identical.

FIG. 3 shows a partial perspective view of another embodiment of the present apparatuses, in which multiple braces 100 are bolted to a rotor body 110 of a rotor assembly 120. Rotor assembly 120 includes multiple poles (the pole bodies of which are not visible). First winding 122 is positioned around one of the poles (and, more particularly, around one of the pole bodies), and second winding 124 is positioned around another of the poles (and, more particularly, around another of the pole bodies). Each brace 100 includes channels 41 extending between two openings 40 in third side 30 and its opposing side (not visible). Channels 41 may, as shown in this figure, have the same shape as openings 40. Planes 50 are not depicted in this figure for clarity, but those of ordinary skill of art will understand, based on this disclosure, that those planes, when positioned as shown in FIGS. 1 and 2, do not intersect either first winding 122 or second winding 124.

Continuing with FIG. 3, each brace 100 has a central segment (designated generally by element number 90) that is positioned between channels 41 and that extends from third side 30 to the opposite side of the brace. Bolts 97 (only portions of the heads of which are visible, and which are not drawn to scale) connect braces 100 to rotor body 110. Rotor body 110 may be provided with bolt openings, or recesses, configured to accept bolts 97 (see FIG. 16). That configuration can be achieved by threading the recesses in embodiments in which bolts 97 are threaded. Furthermore, in another embodiment of brace 100, bolt passageways 95 may be threaded, and no bolt head recess may be used. Although the embodiment of brace 100 shown in FIG. 3 has two bolt passageways, those of ordinary skill in the art will understand based on this disclosure that a single bolt passageway may be alternatively be used in appropriate applications. Those of ordinary skill in the art will also understand that more than two bolt passageways (e.g., 3 or more) may also be used in appropriate applications.

As FIG. 3 shows, first sides 10 of braces 100 are contacting first winding 122 (and, more particularly, the outside of first winding 122), and second sides 20 of braces 100 are contacting second winding 124 (and, more particularly, the outside of second winding 124). First pole tip 126 is connected to the pole body around which first winding 122 is positioned, and second pole tip 128 is connected to the pole body around which second winding 124 is positioned.

Although potentially more costly than using bolts, base 70 of braces 100 (and, more particularly, bottom 72) could be configured with a male connector (such as a male dovetail connector) configured to connect to a corresponding female connector (such as a female dovetail connector) provided in rotor body 110. Braces 100 could then be connected to rotor body 110 by sliding the male connector of each brace into the female connector of rotor body 110. No bolt passageways would be used in such an embodiment.

For the synchronous motor or generator referenced above, the embodiment of braces 100 shown in FIGS. 1-3 may be made from aluminum, such as Al 6061-T6. The rotor body, windings, and poles may be made from standard materials known to those of ordinary skill in the art. For all of the present apparatuses, the connection between the pole bodies and rotor bodies may be made in any suitable fashion known to those of ordinary skill in the art. For example, the connection may be an integral one created from a single forging. Alternatively, dovetail connections may be used, such as where the rotor body includes a female dovetail connection and pole bodies include male dovetail connections.

The present openings braces are configured to help cool the outside of the rotor field windings they contact. As cooling gas (e.g., air) passes through the openings in them, heat transfer takes place. That is, heat from the outside of the windings will pass by conduction to the portions of the braces in contact with the windings. Heat then can pass from the surface of the brace bordering the cooling gas to that cooling gas (e.g., from the brace 100 surface that defines channels 41 to the cooling gas). Heat transfer should increase as the distance between the sides of braces 100 and channels 41 decreases.

Blade Braces

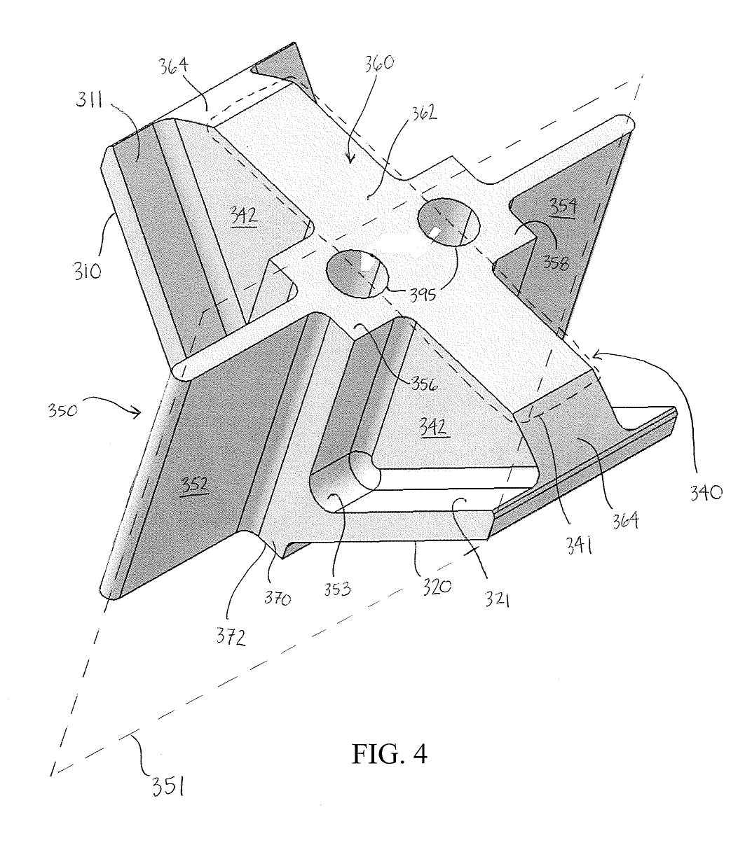

FIG. 4 is a perspective view of another embodiment of the present apparatuses, in which brace 300—which has a blade with portions that act as centrifugal fan blades and help draw air through the openings of the openings braces discussed above—is configured to be bolted to rotor body 110 of rotor assembly 120. A single brace 300 (which may also be characterized as a blade brace) may be positioned in the middle of braces 100 that are positioned at spaced apart intervals along the gap between adjacent windings. FIG. 4 shows a perspective view of the front and top of brace 300. Brace 300, in this embodiment, is symmetrical from front to back; thus, the back of brace 300 is the same as the front and need not be depicted.

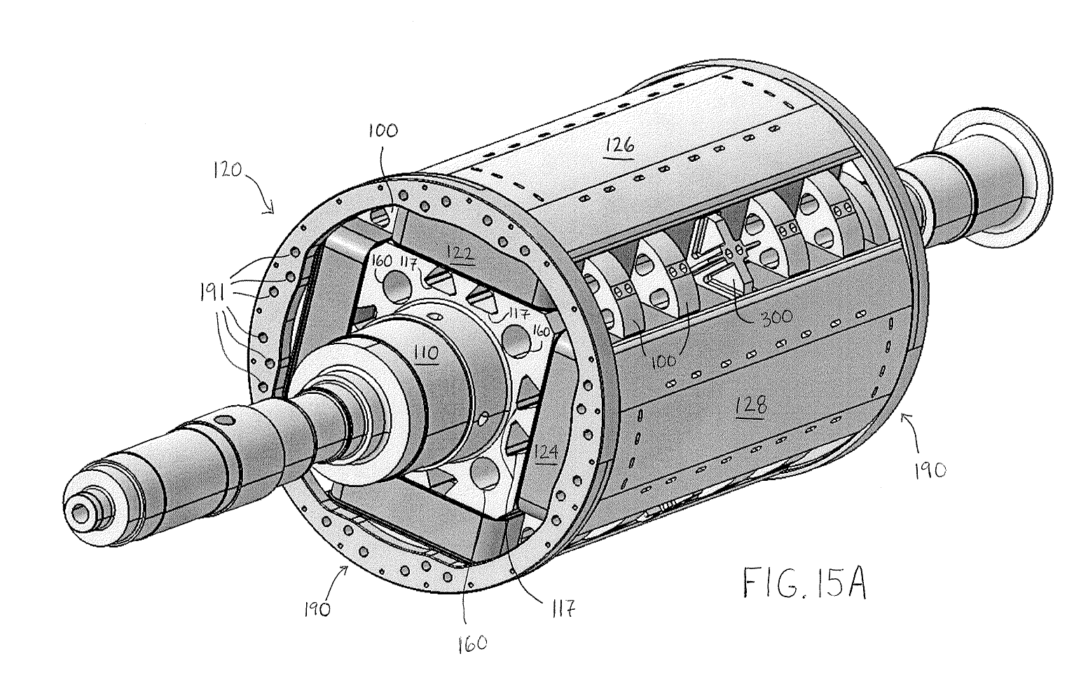

Brace 300 includes a first side 310 that is configured to contact (and that in the embodiment shown in, e.g., FIG. 15 actually contacts) a first winding (e.g., first winding 122) of a rotor assembly (e.g., rotor assembly 120) having a rotation axis (not visible), and a second side 320 that is configured to contact (and that in the embodiment shown in, e.g., FIG. 15 actually contacts) a second winding (e.g., second winding 124) of the rotor assembly (e.g., rotor assembly 120). In this embodiment, both first and second sides 310 and 320 are substantially flat.

Brace 300 also includes a segment 340—a top portion of which is outlined in dashed lines 341—positioned between first and second sides 310 and 320. Brace 300 includes a top side 360, which has a top segment 362 that is substantially flat and lies in a single plane, and two curved segments 364, which connect top segment 362 to each of first and second sides 310 and 320. In another embodiment, top side 360 is a smooth curve that connects first side 210 to second side 220. In another embodiment, top side 360 may be flat and have no curved segments. Brace 300 also includes a base 370 that has a bottom 372.

Brace 300 also includes a blade 350 that lies in a plane 351 (meaning that some portion of the blade lies in plane 351) that intersects segment 340 (in this embodiment, the intersection takes place at a right angle) but not first side 310 or second side 320. Plane 351 intersects the rotation axis (not shown) of rotor assembly 120 in a line. The embodiment of blade 350 shown also runs from top side 360 to bottom 372. Segment 340 has a front side 342, and a corresponding back side that is not visible in this figure, but that is (in this embodiment) identical to front side 342. Blade 350 includes a first blade portion 352 that is nearer front side 342 than the back side of segment 340. Blade 350 also includes a second blade portion 354 that is nearer the back side of segment 340 than front side 342. Blade 350 includes a front side shoulder 356 that extends from front side 342 to first blade portion 352, and that is wider than first blade portion 352; and a back side shoulder 358 that extends from the back side of segment 340 to second blade portion 354, and that is wider than second blade portion 354. Neither front side shoulder 356 nor back side shoulder 358 extends the length of either blade portion; both shoulders in this embodiment end in curves (e.g., front side curves 353) that are positioned above base 370 of brace 300. Brace 300 also has side segments extending toward the center of the brace from the first and second sides. Specifically, first side segment 311 extends from first side 310 toward plane 351. Similarly, second side segment 321 extends from second side 320 toward plane 351.

Continuing with FIG. 4, brace 300 is configured to be bolted to a rotor body by virtue of bolt passageways 393 (which are not drawn to scale), each passageway being provided with a bolt head recess 395 at the top of the passageway. Bolt passageway 393 extends from top surface 360 to bottom 372. Bolt head recess 395 may have a larger diameter than the remainder of bolt passageway 395 extending beneath it toward bottom 372, and may have any suitable depth. Rotor body 110 may be provided with a bolt opening, or recess, configured to accept bolt 397 (e.g., bolt recesses 118 discussed below). That configuration can be achieved by threading the recess in embodiments in which the connecting bolts are threaded. Furthermore, in another embodiment of brace 300, bolt passageways 393 may be threaded, and no bolt head recess may be used. Although the embodiment of brace 300 shown in FIG. 4 has two bolt passageways, those of ordinary skill in the art will understand based on this disclosure that a single bolt passageway may be alternatively be used in appropriate applications. Those of ordinary skill in the art will also understand that more than two bolt passageways (e.g., 3 or more) may also be used in appropriate applications.

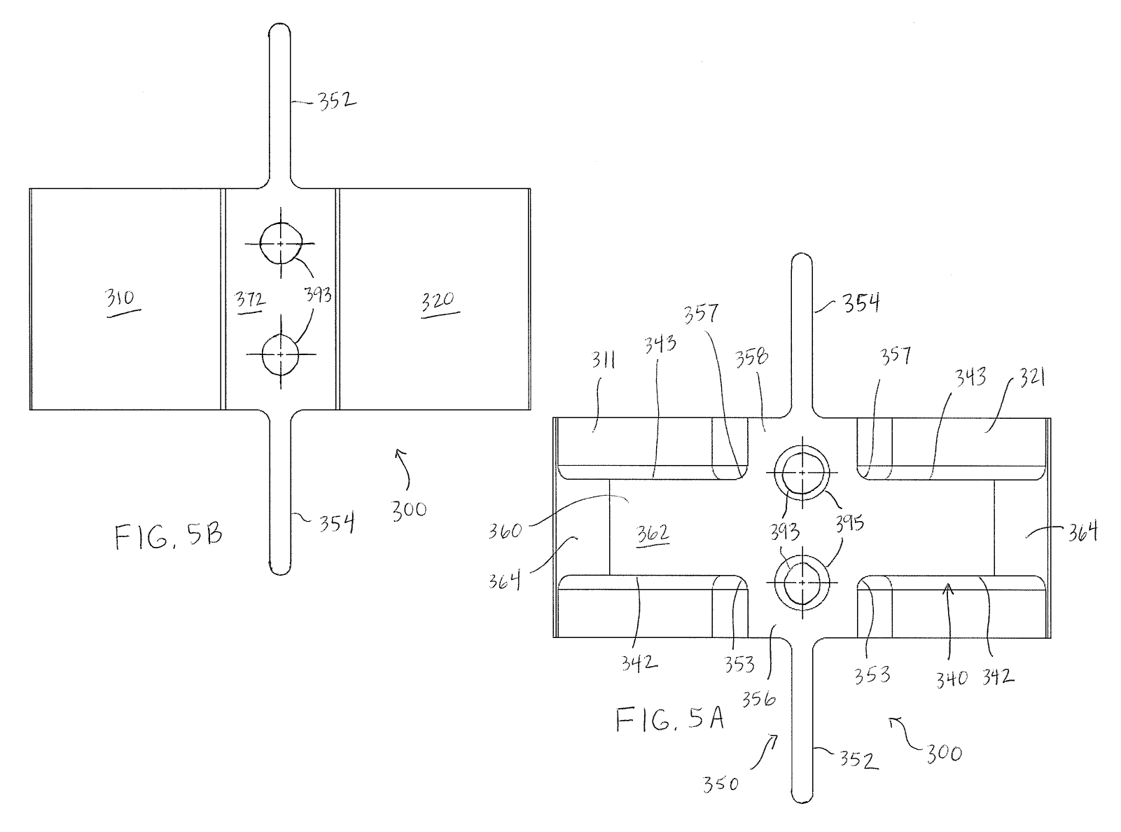

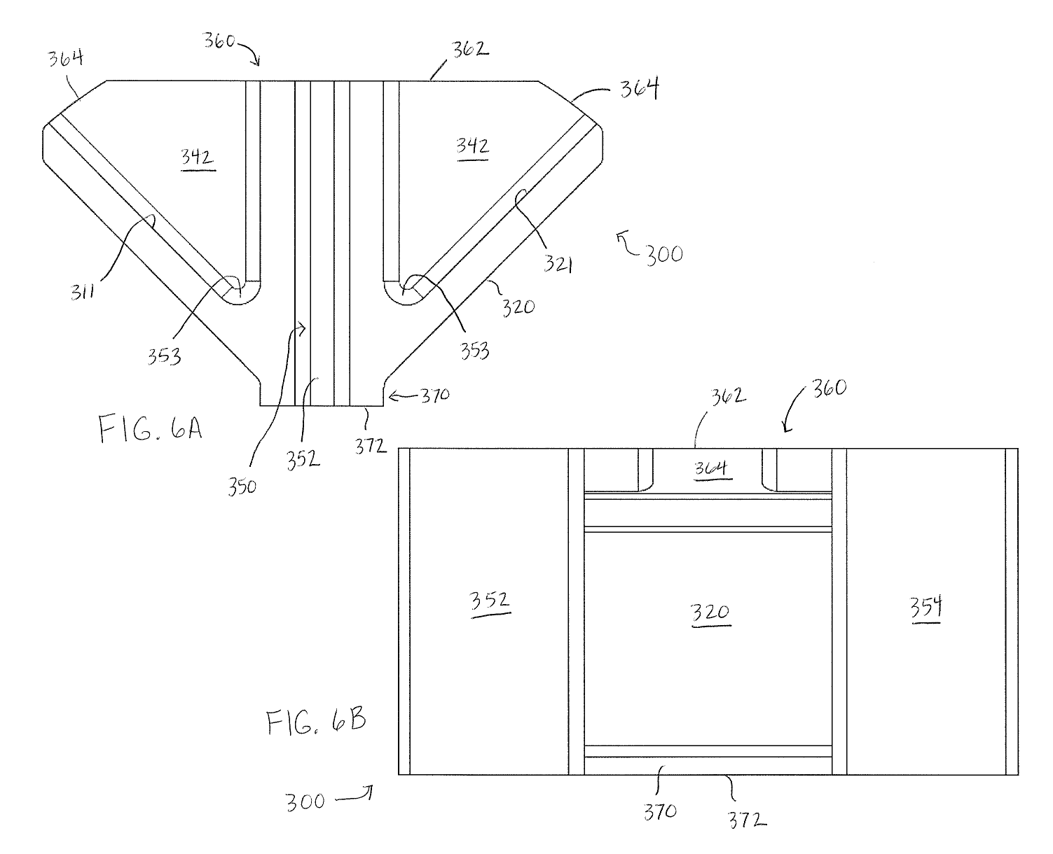

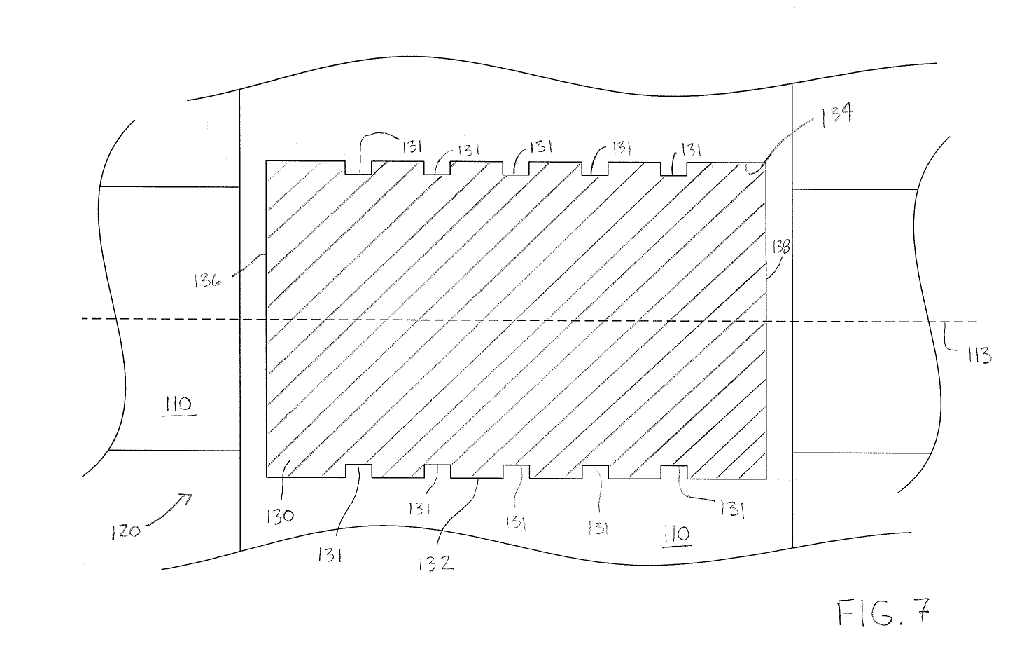

FIGS. 5A and 5B show top and bottom views, respectively, of the embodiment of blade brace 300 shown in FIG. 4. FIG. 5A shows that back side shoulder 358 ends in back side curves 357, which are positioned above base 370 of brace 300. FIG. 5A also shows back side 343 of segment 340. FIGS. 6A and 6B show front and side views, respectively, of the embodiment of blade brace 300 shown in FIG. 4.

The present blade braces, when used in conjunction with, for example, the present openings braces, help to draw cooling gas along the outside of the rotor field windings. They may be centered between a group of openings braces positioned along the gap between adjacent rotor field windings. The blade portions of the centered blade brace will act as centrifugal fan blades that create a low pressure region that drawings cooling gas through the openings in the openings braces and toward the blade portions.

Pole Body Cooling Ducts

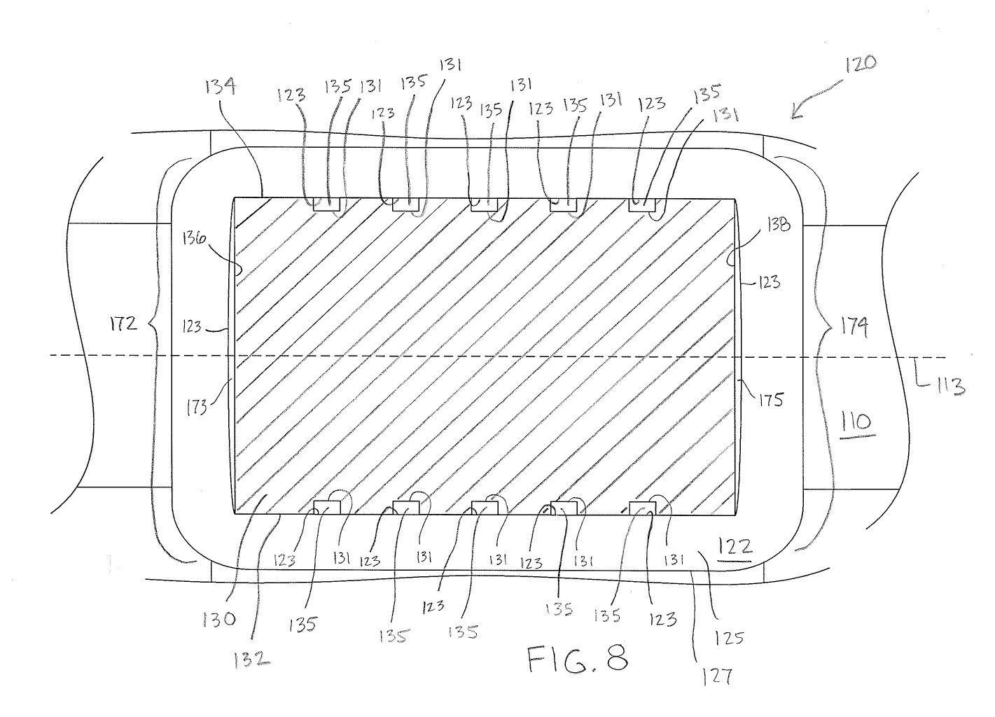

The present pole body cooling ducts are designed to cool the inside of the windings positioned around the pole bodies of rotor assemblies using convection. FIG. 7, which is not drawn to scale, illustrates one embodiment of the present apparatuses that include such a pole body cooling duct. FIG. 7 depicts a partial top view of rotor assembly 120, including rotor body 110 having a rotation axis 113 (the axis around which rotor body 110 rotates), and pole body 130 extending from rotor body 110. The pole tip that was otherwise integral, in this embodiment, with pole body 130 has been removed, and the remainder of pole body 130 is depicted in cross-section. Pole body 130 may be non-laminated or laminated.

Pole body has a first side 132 in which a recess 131 is positioned. More specifically, multiple recesses 131 are positioned in first side 132. Pole body 130 also includes a second side 134 in which a recess 131 is positioned. More specifically, multiple recesses 131 are positioned in second side 134. Although recesses 131 in FIG. 7 are depicted as rectangular in shape, other shapes may be used, such as those with curves. Recesses 131 all may have the same dimensions, or one or more may have different dimensions, especially in applications that require greater convective cooling along certain portions of the winding than others.

In the embodiment shown in FIG. 7, each recess 131 is substantially perpendicularly to rotation axis 113. In other embodiments, some or all of the recesses may be not substantially perpendicular to rotation axis 113. For example, another embodiment of recess 131 might have a non-uniform depth along its length. Furthermore, the embodiment of recesses 131 in FIG. 7 is substantially straight. However, in other embodiments, some or all of the recesses may have a curve, especially if a curve will be useful for a given application.

Continuing with FIG. 7, pole body 130 has third side 136 and fourth side 138. Third side 136 is spaced apart from and substantially parallel to fourth side 138; both are substantially perpendicular to rotation axis 113. In some embodiments of the present apparatuses, any or all of the sides of pole body 130 (including first side 132, second side 134, third side 136, and fourth side 138) may be curved, or have one or more curves. Third side 136 is substantially perpendicular to first and second sides 132 and 134. The same is true of fourth side 138. First and second sides 132 and 134 may have substantially the same length, and third and fourth sides 136 and 138 may have substantially the same length. This may be true for some or all of the pole bodies extending from rotor 110. Third side 136 is shorter than at least two of the other sides (e.g., first and second sides 132 and 134) of pole body 130, as is fourth side 138. Third and fourth sides 136 and 138 also may be characterized as being sides positioned at the ends of pole body 130.

FIG. 8, which is not drawn to scale, is a similar view to FIG. 7, except that first winding 122 is positioned around pole body 130. Rotor assembly 120 depicted in FIG. 7 includes a pole body cooling duct 135 that is formed by at least a recess 131 and first winding 122. More particularly, rotor assembly 120 includes multiple pole body cooling ducts 135, each being formed by at least a recess 131 and first winding 122. Even more particularly, rotor assembly 120 includes multiple pole body cooling ducts 135, each being formed by at least a recess 131 and inside surface 123 of first winding 122. First winding 122 also includes top surface 125, and outside surface 127. First winding 122 includes a bottom surface that is in contact with rotor body 110, and not visible in FIG. 8. In some embodiments, the present pole body cooling ducts are not gas-tight. In such embodiments, gas (e.g., air) traveling within a given pole body cooling duct may escape to space between (a) the wound material in a winding, (b) first side 132 and inside surface 123 of first winding 122, or (c) second side 134 and inside surface 123.

Continuing with FIG. 8, first winding 122 has end sections: first end section 172 and second end section 174. These end sections of first winding 122 have at least a portion that is substantially perpendicular to rotation axis 113. These end sections are positioned beside third and fourth sides 136 and 138, respectively. These end sections extend between the longitudinal sections (unnumbered) of first winding 122, which are positioned beside first and second sides 132 and 134, respectively, of pole body 130. Inside surface 123 (also characterizable as the inside) of first winding 122, and of the first and second end sections of first winding 122, borders two spaces: first space 173 and second space 175. More particularly, first space 173 is bordered by inside surface 123 and by third side 136 of pole body 130, and second space 175 is bordered by inside surface 123 and by fourth side 138 of pole body 130. Fist winding 122 may be prepared in such a way that inside surface 123 is slightly curved at end sections 172 and 174—as shown in this embodiment—to allow for the creation of the two spaces.

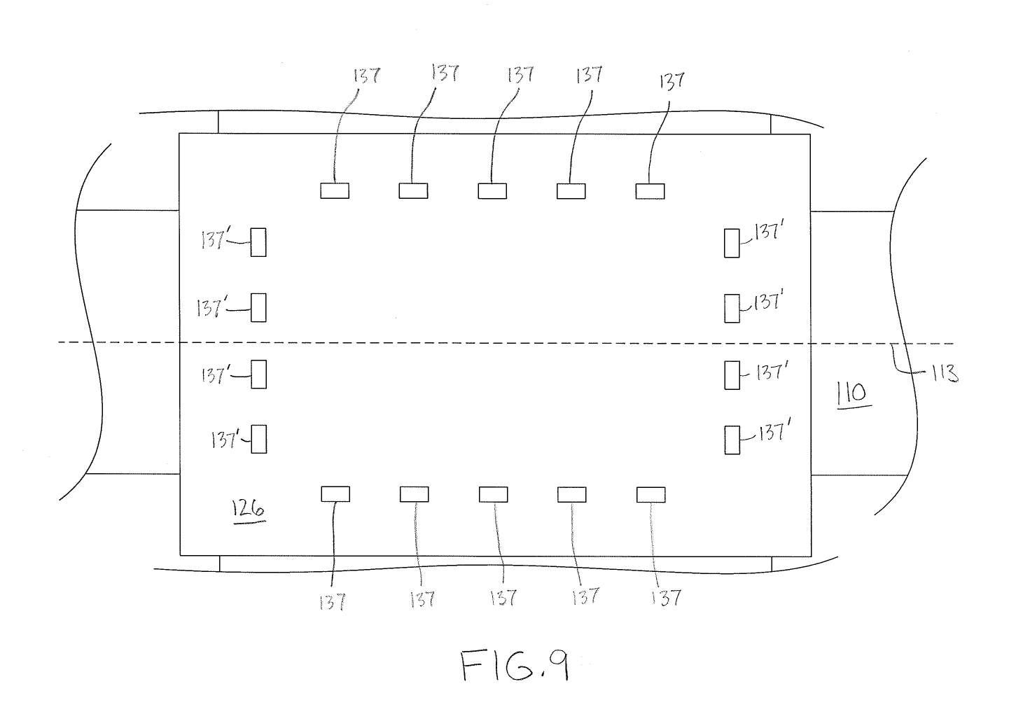

FIG. 9, which is not drawn to scale, illustrates that first pole tip 126, which may be integral with pole body 130, may have a passageway 137. More particularly, first pole tip 126 may have multiple passageways 137. One or more of passageways 137 (e.g., each passageway 137) may be in fluid communication with a pole body cooling duct 135.

All passageways 137 may have the same dimensions, or one or more may have different dimensions to best suit a given application. One or more of passageways 137 may have the same shape as the pole body cooling ducts 135 with which they are in fluid communication. In other embodiments, a passageway 137 may have a larger or smaller shape (e.g., cross-sectional area) than a pole body cooling duct 135 with which the passageway is in fluid communication.

Each passageway 137 may be substantially perpendicular to rotation axis 113, as shown in FIG. 9. In other embodiments, however, only some or none of passageways 137 are substantially perpendicular to rotation axis 113. For example, in other embodiments, one or more passageways 137 may be angled through a given pole tip, especially if having such an angle will be useful for a given application. Further, each passageway 137 may be substantially straight, as shown in FIG. 9. In other embodiments, however, some or all of the passageways may have a curve, especially if a curve will be useful for a given application.

Continuing with FIG. 9, first pole tip 126 may be provided with a passageway 137′ that is in fluid communication with first space 173 or first space 175. More particularly, first pole tip 126 is shown as having multiple passageways 137′, some of which are in fluid communication with first space 173, and some of which are in fluid communication with second space 175. Passageways 137′ may have the same size, shape, and orientation as passageways 137. However, passageways 137′ may have any size, shape, and orientation that is suited to a particular application.

The size of spaces 173 and 175 may be enlarged in any suitable way to increase the ability to convectively transfer heat away from winding 122. For example, recesses—similar to recesses 131 in first and second sides 132 and 134—may be provided in third and/or fourth sides 136 and 138. Such recesses may have any of the shapes described above for use with recesses 131. As another alternative, inside surface 123 may be provided with a more recessed curve than is shown in FIG. 8, such that the distance between outside surface 127 and inside surface 123 is reduced further along end sections 172 and 174 of first winding 122 than what is shown in FIG. 8.

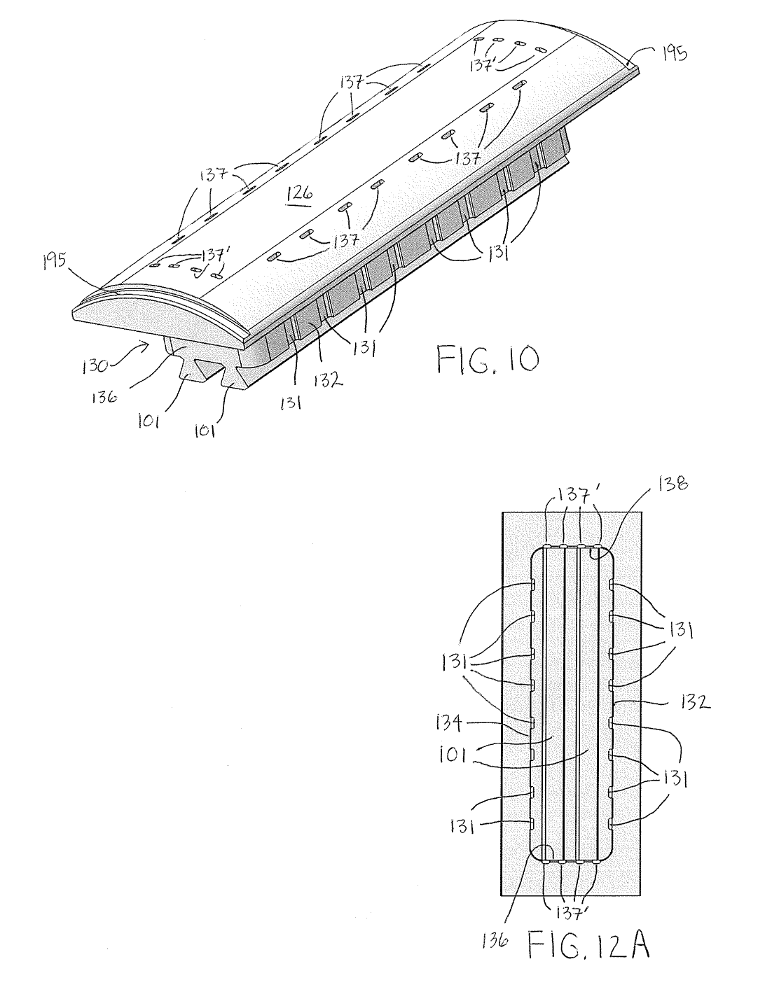

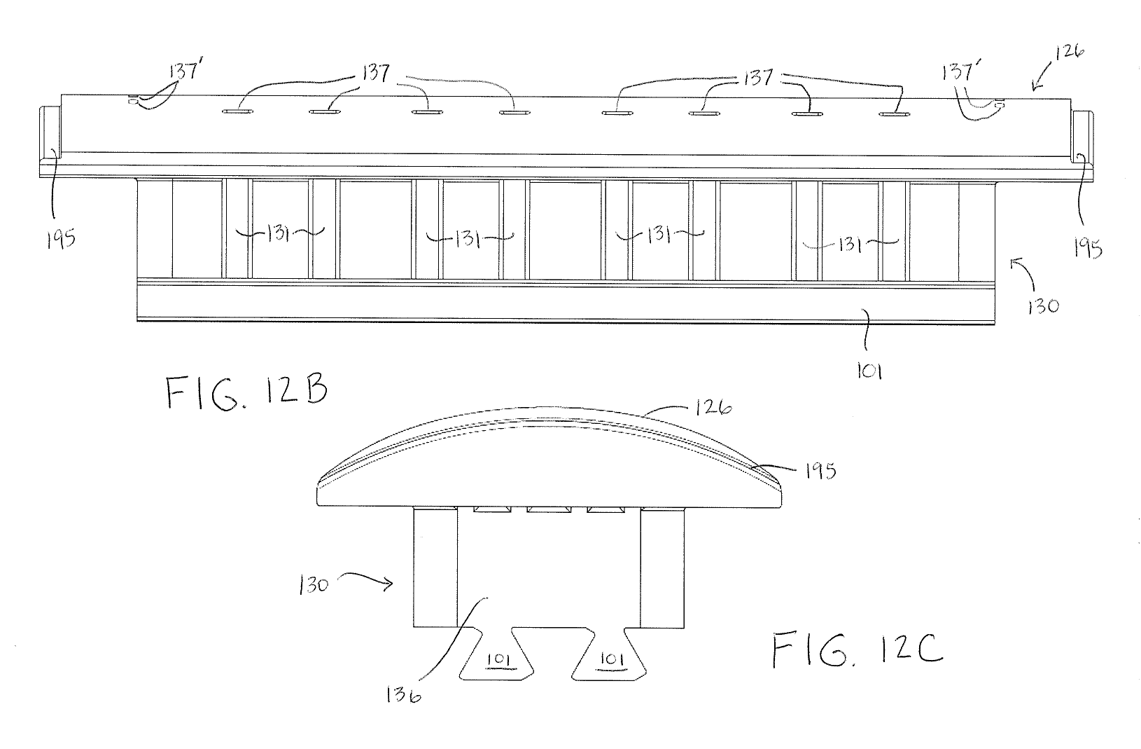

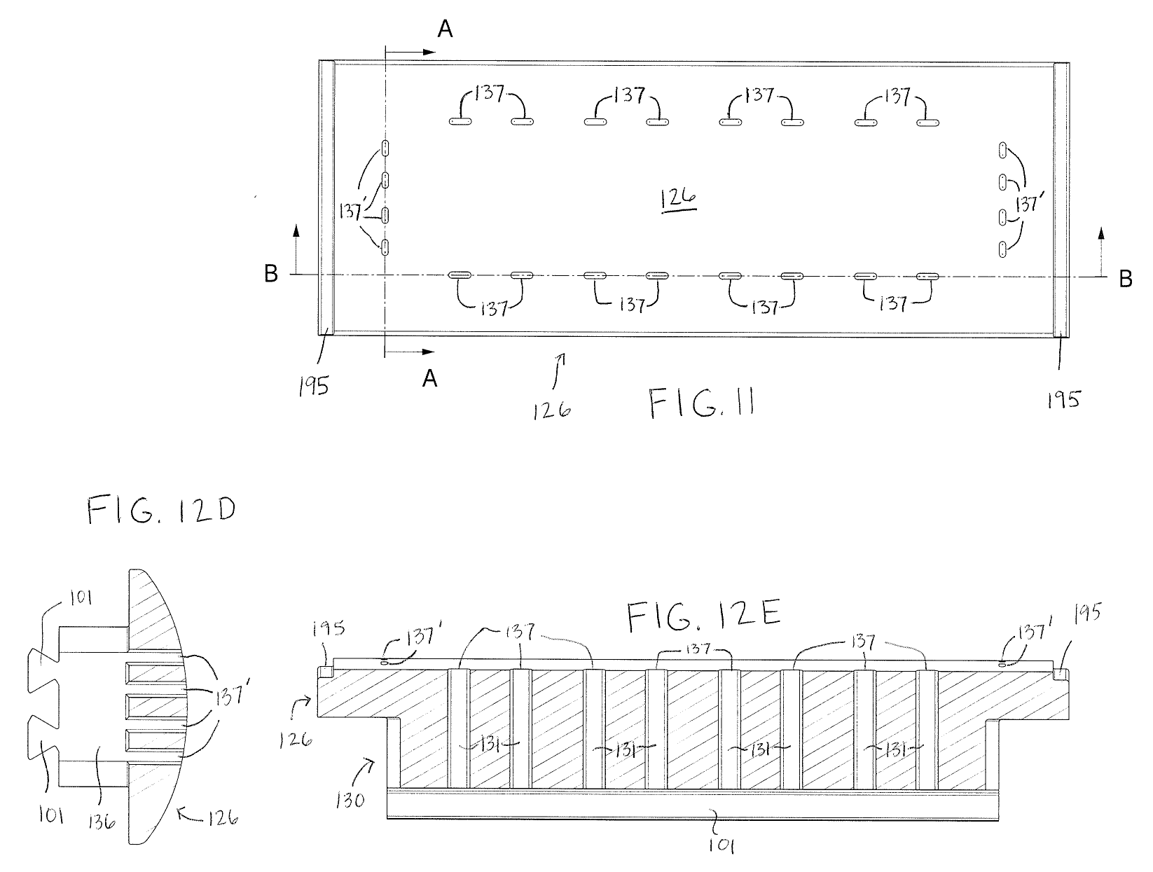

FIGS. 10-12E show different views of one embodiment of a pole that may be used consistently with the present apparatuses. The pole includes pole body 130 and first pole tip 126, which is integral with pole body 130. The pole also includes triangular-shaped male connectors 101 that extend from the bottom surface of the pole body and that are configured to mate with corresponding triangular-shaped female connectors (e.g., female connectors 117 discussed below) of a rotor body. FIGS. 10 and 11 also show that the pole tip of a given pole body may have a portion cut out of it at its ends so as to create a recessed portion 195 onto which a resistance ring (e.g., resistance ring 190 discussed below) may be placed. FIGS. 12A, 12B, and 12C are bottom, side, and end views, respectively, of the pole body shown in FIG. 10. FIGS. 12D and 12E are cross-sectional views of the same pole body, taken along lines A-A and B-B, respectively, in FIG. 11. As FIG. 12E shows, pole tip passageways 137, in this embodiment, are in fluid communication (direct fluid communication, in this embodiment) with recesses 131 in pole body 130.

Rotor Body Cooling Ducts

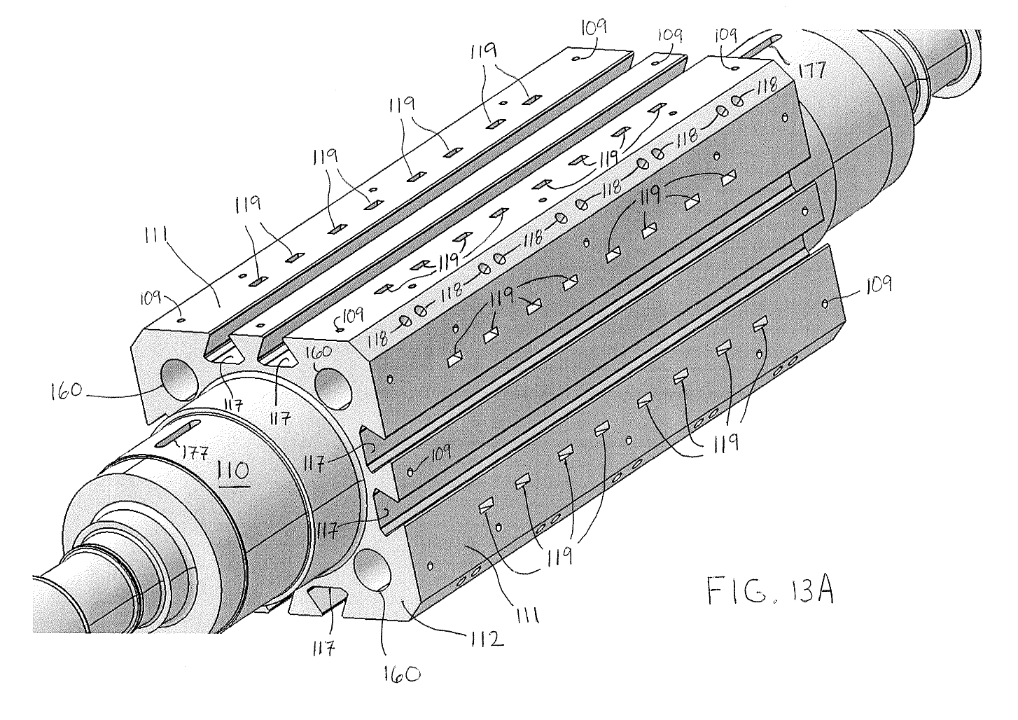

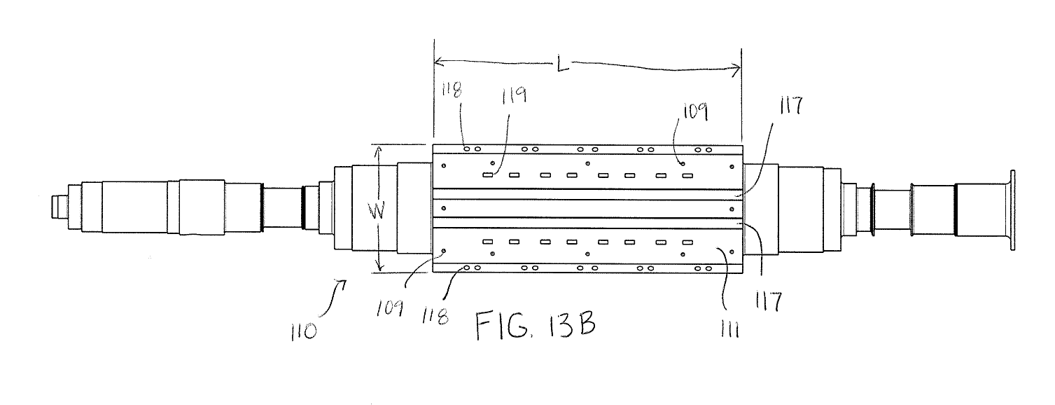

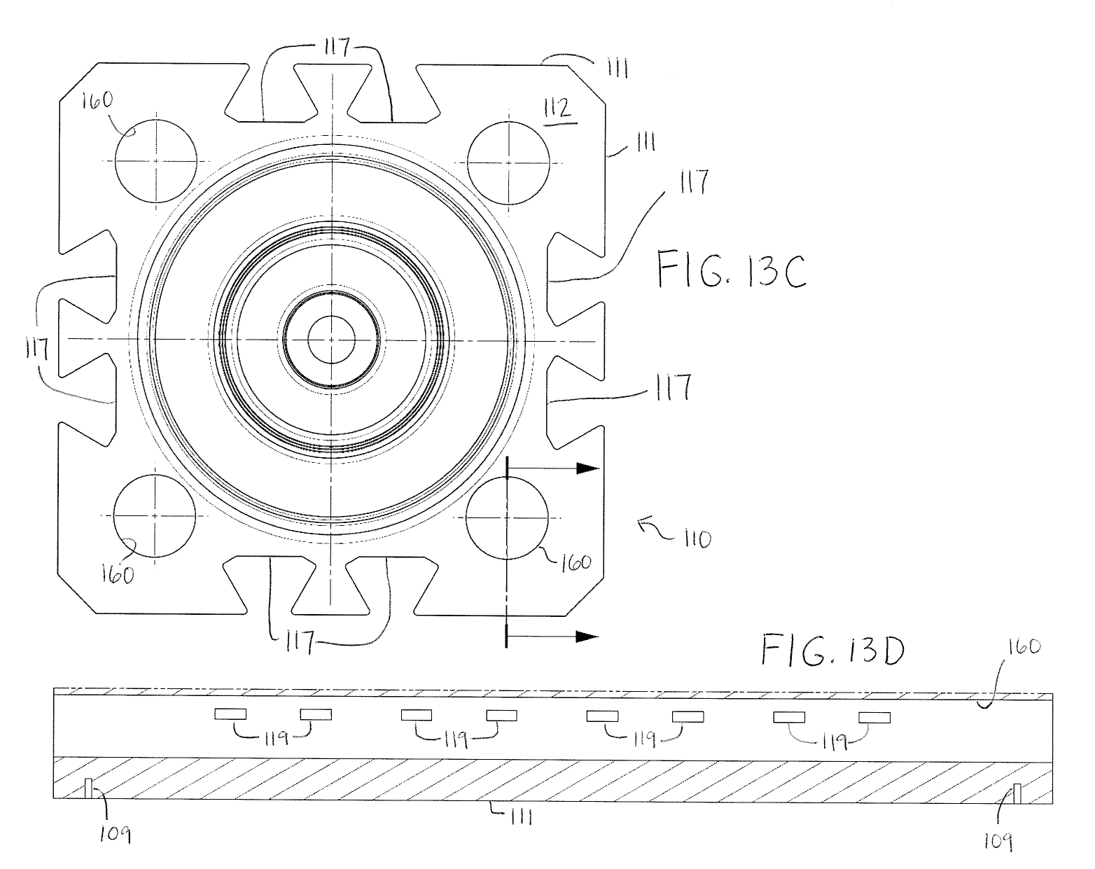

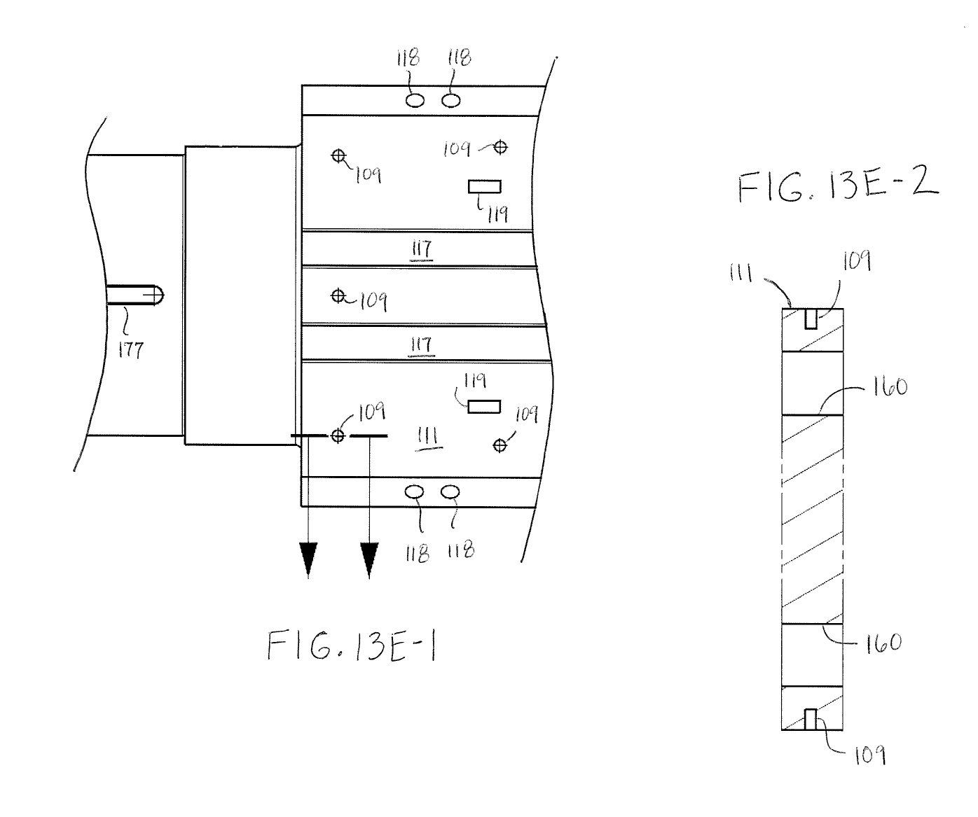

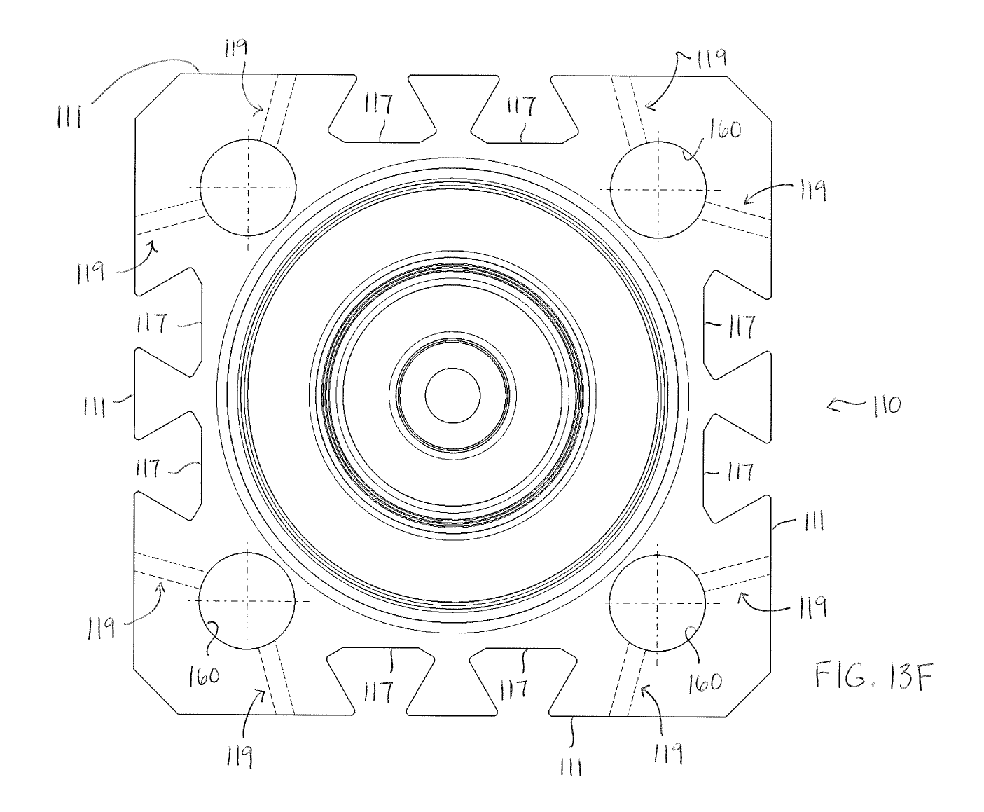

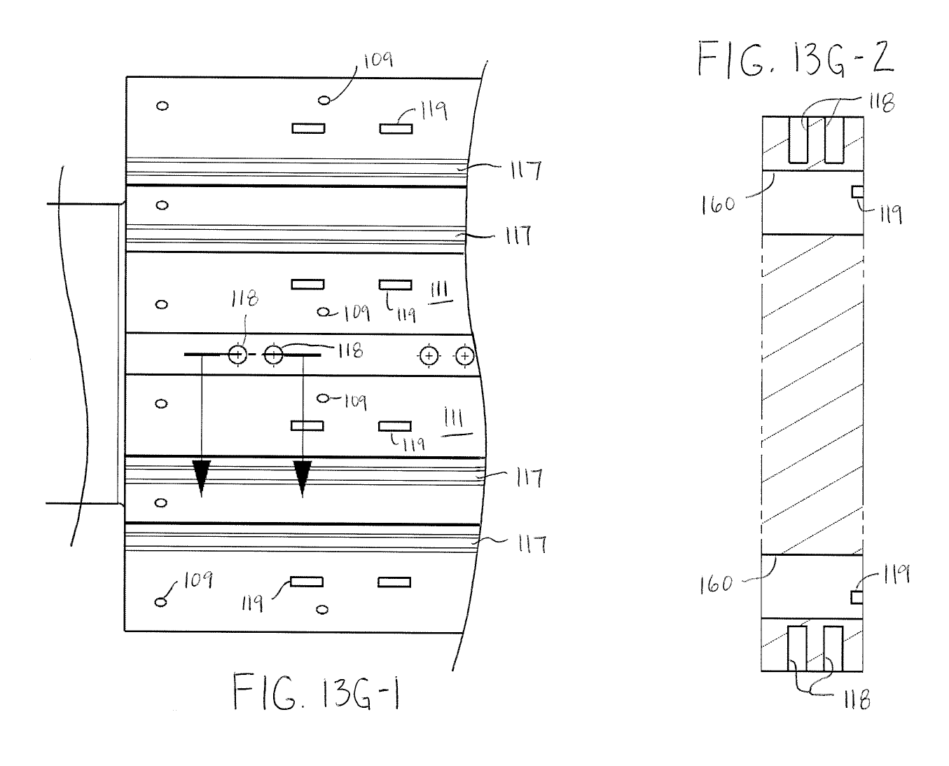

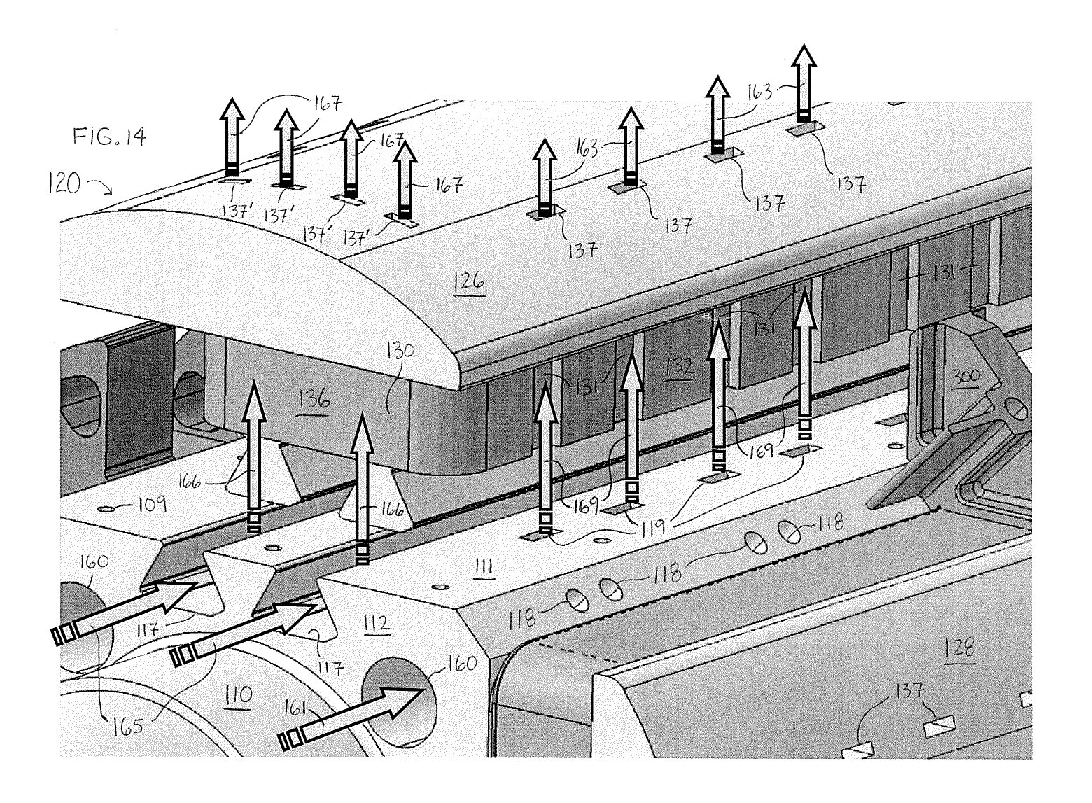

Cooling ducts may be provided in the rotor bodies that are used with the present braces and pole body cooling ducts. An example of such cooling ducts are shown in FIG. 13A, which depicts a partial view of a rotor body 110. As shown, rotor body 110 may have one or more (e.g., multiple, as in the depicted embodiment) rotor body cooling ducts 160. One or more of rotor body cooling ducts may, as shown in FIG. 14, be in fluid communication with one or more of the pole body cooling ducts that are defined by at least recesses 131 and first winding 122. One or more of rotor body cooling ducts 160 may be substantially straight and substantially parallel to the rotation axis of rotor body 110. Although the embodiment of the rotor body cooling ducts in this figure are circular in cross-section, any suitable shape may be used, including rectangular (e.g., square), oval, etc.

As FIG. 13A illustrates, one or more (e.g., all) rotor body cooling ducts 160 may start at openings provided in side face 112 of rotor body 110. In this embodiment, side face 112 is substantially flat and substantially perpendicular to the rotation axis of rotor body 110. One or more rotor body cooling ducts 160 may extend to an opposing side face (not visible) of rotor body 110, such that a given rotor body cooling duct extends from an opening positioned in one rotor body side face to an opening positioned in another rotor body side face, or they may terminate somewhere between the ends (and, more particularly, the side faces) of the rotor body. The fluid communication that may exist between one of the present rotor body cooling ducts (such as rotor body cooling ducts 160) and one of the present pole body cooling ducts may be achieved in any suitable manner, including by configuring the rotor body cooling duct to terminate in an opening in the rotor body that is adjacent to (or otherwise in fluid communication with) a recess that is part of a pole body cooling duct, creating a rotor body passageway (e.g., a rotor body branch) in the rotor body that links the rotor body cooling duct to such an opening (where the rotor body passageway (see passageway 119 discussed below) and rotor body cooling duct are at angles to each other; the rotor body passageway may be substantially straight and substantially perpendicular to the rotation axis, it may have one or more curves, and it may have any suitable shape—such as circular or rectangular), or the like.

In some embodiments, one or more of the present rotor body cooling ducts are not gas-tight. For example, the embodiment of rotor body 110 in FIG. 13A includes female triangular-shaped connectors 117 that are configured to connect to corresponding male triangular-shaped connectors projecting from the bottom surface of a pole body (not shown). As shown in this embodiment, female dovetail connectors 117 may extend from side face 112 of rotor body 110 to the side face at the opposite end of the rotor body. Some space will exist between female connectors 117 and the male connectors of the pole body, even after keys have been used to better secure the two structures together. Moreover, at least a portion of a given female connector 117 will be positioned beneath the bottom surface of the winding that is positioned around the pole body, and that portion will not be occupied by a male connector of a pole body (this is clear in FIG. 14). Thus, gas will be able to travel along the unoccupied portion of the female connector 117, and into and along the space between that female connector and the male connectors disposed in it. Such an unoccupied portion of female connector 117 and the space between the pole body male connector and the female connector qualifies as a rotor body cooling duct that comprise a type of groove. Gas may escape from the unoccupied portion of female connectors 117 through gaps between the portion and the winding, and the same is true of gas traveling through the space between the female connectors 117 and the pole body male connectors. Thus, such rotor body cooling ducts are not gas-tight.

Continuing with FIG. 13A, the embodiment of rotor body 110 that is shown includes passageways 119 that put rotor body cooling ducts 160 in fluid communication with the pole body cooling ducts discussed above. The embodiment of passageways 119 are positioned in rotor body 110 such that they begin (or end, depending on the perspective taken) at openings positioned in a surface of rotor body 110 on, or over, which a pole body and a winding can be positioned (e.g., surface 111), and they end (or begin, depending on the perspective taken) at openings created by the intersection of a given passageway 119 and rotor body cooling duct 160 (the intersection not being visible). Also shown are bolt recesses 118 that may be configured to accept the bolts used to hold down either the openings braces or the blade braces discussed above. Also shown are rotor body recesses 109 (not all are numbered), which may be sized to accept springs that can bias a plate positioned beneath a given winding toward the pole tip that is placed over that winding (such that the winding does not otherwise move suddenly against (e.g., slam into) the pole tip due to the centrifugal force created when the rotor body begins to rotate.

FIG. 13B shows a front of view of rotor body 110. This view represents the top, back, and bottom views of the rotor body as well, save the existence of grooves 177 (discussed below) that would be visible in the top and bottom views. FIG. 13C is an end view of rotor body 110 (either end because of the symmetry of the rotor body). FIG. 13D is a partial cross-sectional view of the rotor body, taken along the line shown in FIG. 13C. FIG. 13D shows that passageways 119 extend into the rotor body from surface 111 until they meet the relevant rotor body cooling duct 160. In some embodiments, dimension L in FIG. 13B may be 57.00 inches and dimension W may be 23.26 inches, such as those embodiments of a rotor assembly that includes a rotor body of a synchronous motor or generator having a salient pole design, four poles, and a capability of 15,000 HP.

FIG. 13E-1 is a partial top view of rotor body 110, and FIG. 13E-2 is a partial cross-sectional view of the rotor body taken along the line shown in FIG. 13E-1, showing an exemplary depth of rotor body recesses 109 (as does FIG. 13D), all of which may be the same.

FIG. 13F is a left end view of rotor body 110, showing passageways 119 in phantom (dashed lines). As this figure shows, passageways 119 can be oriented at an angle to the respective surface 119 from which they begin/end, and extend into the relevant rotor body cooling duct 160.

FIG. 13G-1 is a partial top view of rotor body 110, and FIG. 13G-2 is a partial cross-sectional view taken along the line shown in FIG. 13G-1, showing an example depth for bolt recesses 118.

FIG. 14 is a partial view of a rotor assembly 120 in which pole body 130 and first pole tip 126 are shown elevated above a surface 111 of rotor body 110. First winding 122 is not depicted such that the gas flow paths described above can be seen more clearly.

For example, this figure illustrates that each of the present pole body cooling ducts can help to cool a winding that is positioned around a pole body. In the embodiment of rotor assembly 120 shown in FIG. 14, each pole body cooling duct that is formed by at least a recess in a side of a pole body and a winding is in fluid communication with a rotor body cooling duct. Cooling of the windings may occur at least by virtue of the convective heat transfer between the gas passing through a particular pole body cooling duct and the winding that borders that pole body cooling duct. Conductive heat transfer may take place as well, to the extent that gas traveling through the pole body cooling ducts draws heat away from a pole body, making the pole body cooler than the winding positioned around it, and then heat transfers by conduction between the hotter winding and the cooler pole body. As a rotor assembly is rotated, cooling gas (e.g., air) may be forced (e.g., by an embodiment of fan system 180 discussed below) into a rotor body cooling duct that is in fluid communication with a pole body cooling duct. This is illustrated, for example, by arrow 161 in FIG. 14. The gas should then travel to the pole body cooling ducts (e.g., ducts 137) via passageways 119 as illustrated by arrows 169, thus helping to cool the winding positioned around the pole body. Exemplary gas travel through pole body cooling ducts 137 is illustrated by arrows 163. Centrifugal forces may be induced by the passageway or passageways in the pole tip that are in fluid communication with the pole body cooling ducts, further drawing cooling gas into the rotor body cooling duct or ducts to further improve the cooling effect on the windings.

FIG. 14 also illustrates that rotor body cooling ducts may be provided in rotor body 110 that are in fluid communication with first and second spaces 173 and 175 (not visible). Each of such spaces may be used in combination with any of the present rotor body cooling ducts to help to cool the windings. Such cooling may occur at least by virtue of the convective heat transfer between the gas passing through a particular rotor body cooling duct and those spaces. Conductive heat transfer may take place as well, to the extent that gas traveling through those spaces draws heat away from a pole body, making the pole body cooler than the winding positioned around it, and then heat transfers by conduction between the hotter winding and the cooler pole body. As a rotor assembly is rotated, cooling gas (e.g., air) may be forced (e.g., by an embodiment of fan system 180 discussed below) into a rotor body cooling duct that is in fluid communication with such a space. This is illustrated, for example, by arrows 165. After the gas travels through those ducts, it should travel through the referenced spaces as indicated by arrows 166, and further through any passageways in the pole tip (e.g., passageways 137′) that are in communication with those spaces, as indicated by arrows 167. Such gas travel should help to cool the winding positioned around the pole body. Centrifugal forces also may be induced by the passageway or passageways in the pole tip that are in fluid communication with the referenced spaces, and thus with the referenced rotor body cooling ducts, further drawing cooling gas into the rotor body cooling ducts to further improve the cooling effect on the winding.

FIG. 15A is a perspective view of an assembled version of an embodiment of rotor assembly 120 that includes both rotor body cooling ducts formed by female connectors 117 as described above and rotor body cooling ducts 160. Many of the features described above are illustrated without reference numbers for clarity. FIG. 15A also shows that a resistance ring 190 (or ring 190) may be placed around a portion of each of the pole tips of a given motor or generator, and at one or both ends of a given motor or generator. Resistance ring 190 may be heat shrunk onto rotor assembly 120, as is well known in the art. To further secure resistance ring 190 to rotor assembly 120, pole tip connection openings 191 may be provided in resistance ring 190 (and openings corresponding in location to them can be provided in the pole tips) such that resistance ring 190 also can be bolted to the pole tips. As a result, the ring will function to hold the four poles together against the centrifugal force that will otherwise tend to separate the poles from the rotor body during use of rotor assembly 120. In some embodiments, ring 190 may be made from a single piece of material, such as copper, which can improve the current flow between each pole. Such an embodiment is shown in FIGS. 15B-15D. The version of ring 190 shown in FIG. 15A has multiple pieces, though need not, as shown in FIGS. 15B-15D. In particular, FIGS. 15B, 15C, and 15D show outer (exposed) end, side, and inner (not exposed) end views, respectively, of an embodiment of resistance ring 190.

FIG. 16 is a perspective view of another embodiment of the present apparatuses. Fan system 180 is configured to be connected to a rotor body, such as rotor body 110, and includes inner mounting ring 182, which has an inside 181 (e.g., an inner surface) and an outside 183 (e.g., an outer surface); and middle ring 186, which has an inside 184 and an outside 187 and is spaced apart from inner mounting ring 182. Fan system 180 also includes an outer ring 189 that includes an inside 191 and an outside 193 and that is spaced apart from middle ring 186. In some embodiments, fan system 180 may be sized such that outer ring 189 has a width RW of 6.00 inches (see FIG. 17C).

One manner of configuring fan system 180 to be connected to a rotor body is to size inner mounting ring 182 such that it can be heat shrunk onto a portion of the shaft of a rotor body. A groove may also be provided in inside 181 (such as groove 179) that is configured to mate with a key positioned in a groove (such as groove 177 in FIG. 13A) in the rotor shaft; such a groove will help prevent fan system 180 from slipping as the rotor shaft turns. Fan system 180 may be configured to be connected to a rotor body in other suitable fashions as well.

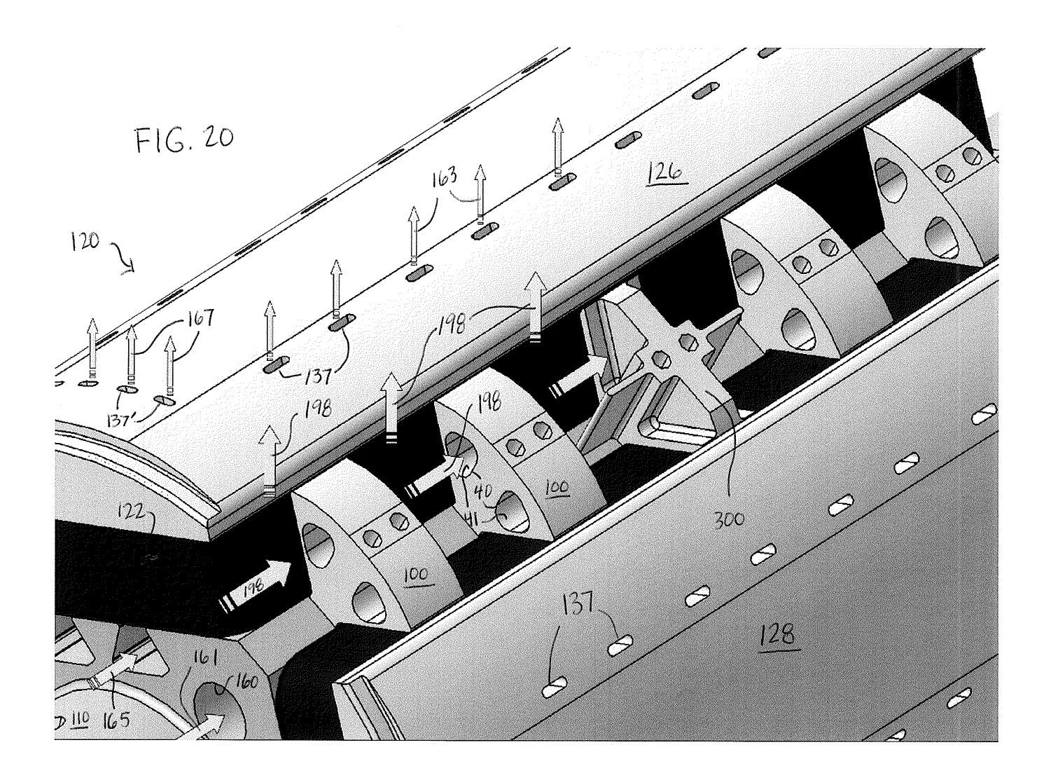

Fan system 180 also includes inner fan blades 185 that, as FIG. 16 shows, are positioned nearer inside 184 (inner surface) of middle ring 186 than outside 187 of middle ring 186. Fan system 180 also includes outer fan blades 188 that, as FIG. 20 shows, are positioned nearer outside 187 of middle ring 186 than inside 184 of middle ring 186. The number of outer fan blades 188 may the same as (shown) or different than the number of inner fan blades 185. The pitch of each inner fan blade 185 may the same as the pitch of every other inner fan blade 185 (shown), or the pitches may vary in order to best suit a given application. The pitch of each outer fan blade 188 may the same as the pitch of every other inner fan blade 188 (shown), or the pitches may vary in order to best suit a given application. The pitches of the inner and outer fan blades may be the same or they may differ to best suit a given application. In this way, the pressure head that is created by the inner fan blades can be set independently of the pressure head that is created by the outer fan blades.

The connection between inner mounting ring 182 and inner fan blades 185 may be achieved in any suitable fashion, such as through welding. The connection between inner fan blades 185 and middle ring 186 also may be achieved in any suitable fashion, such as through welding. The connection between outer fan blades 188 and middle ring 186 may be achieved in any suitable fashion, such as through welding. The connection between outer fan blades 188 and outer ring 189 also may be achieved in any suitable fashion, such as through welding.

FIG. 17A shows a perspective view, taken from the back side of fan system 180. This figure illustrates that the widths of the different rings of fan system 180 can be different. More specifically, this figure shows that, in one embodiment of fan system 180, the width WM of middle ring 186 can be greater than the width WO of outer ring 189.

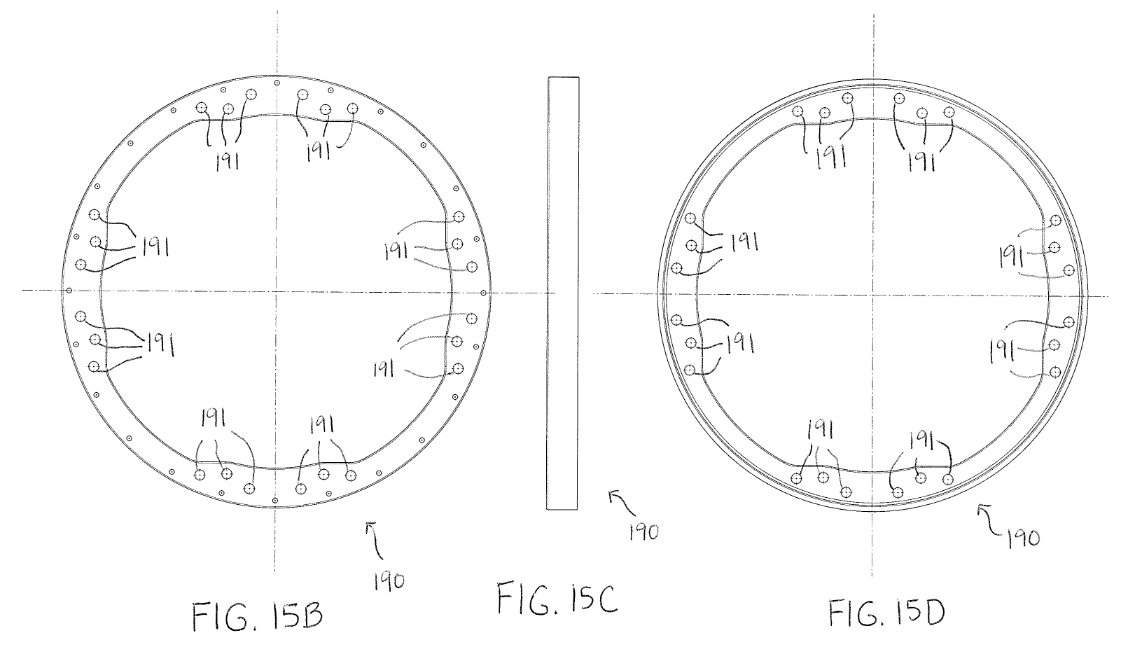

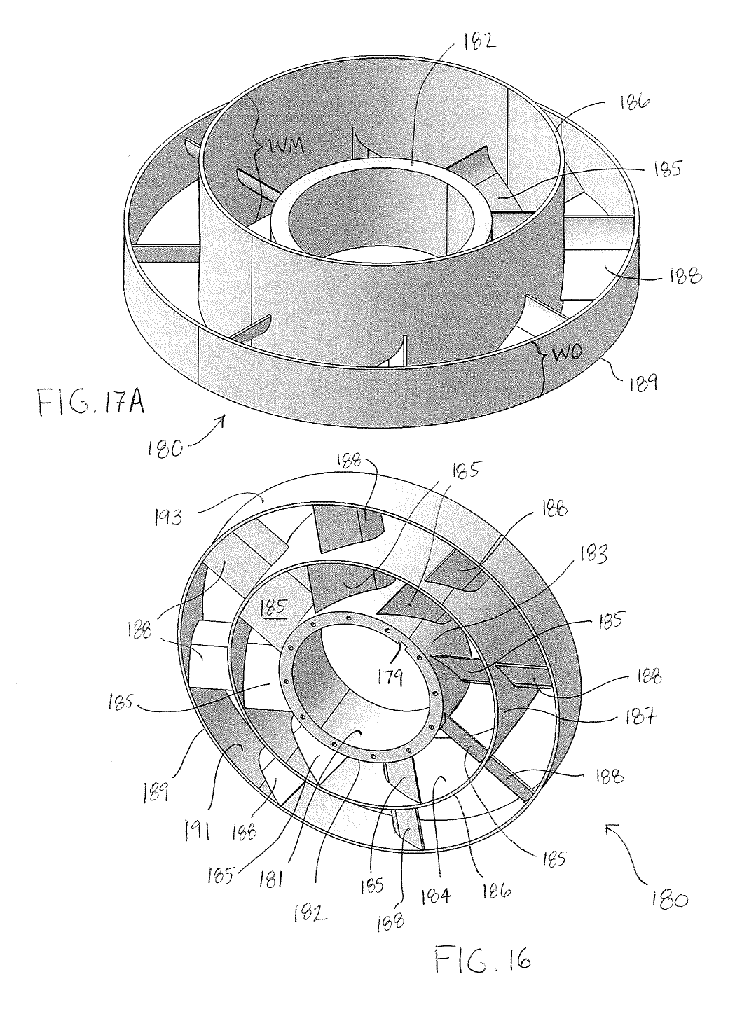

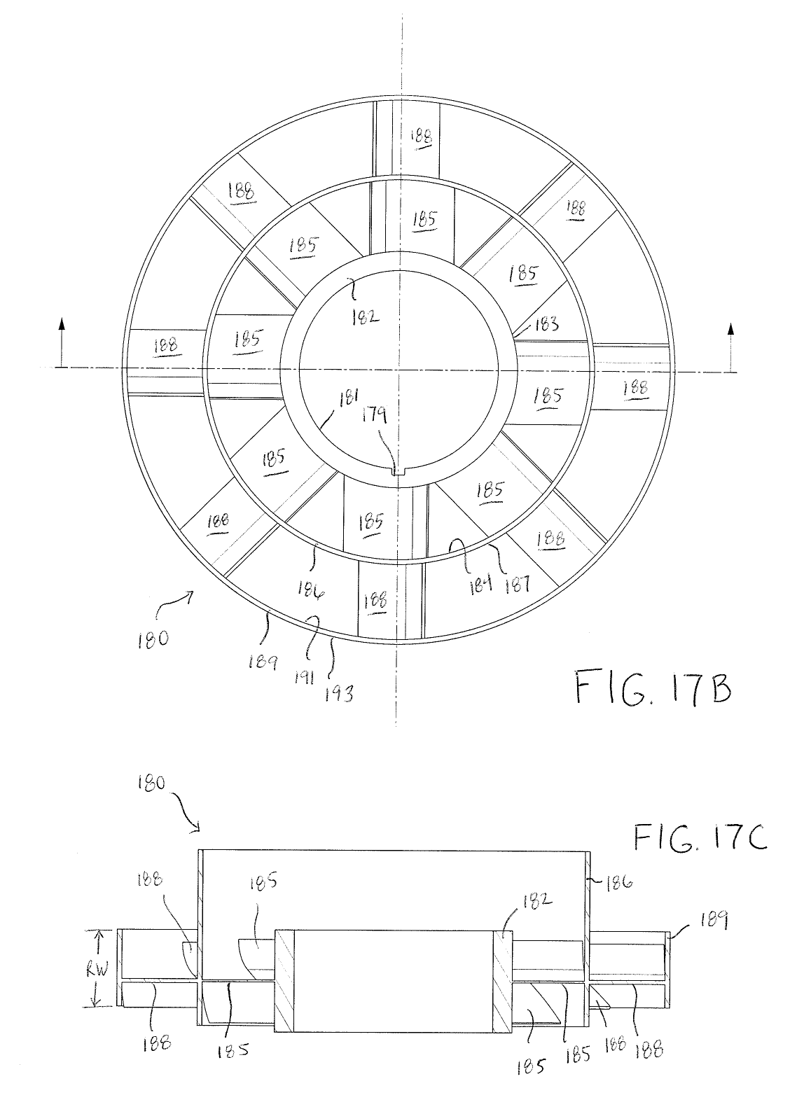

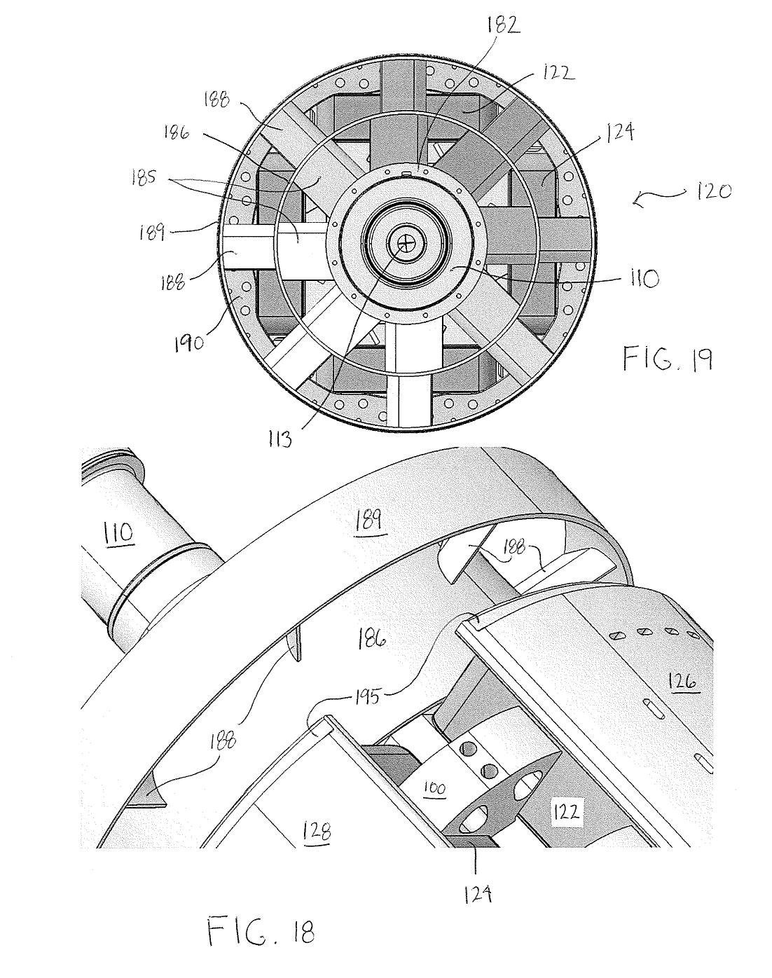

The effect on cooling that can be created by the difference in these widths is best shown in FIG. 18, which is a partial perspective view of one embodiment of rotor assembly 120. FIG. 18 shows that the width of middle ring 186 may be configured such that the fan system will, during rotation, create an outer pressure head (a pressure head created by the rotation of outer fan blades 188) that has a substantially separate effect on winding cooling than the created inner pressure head (a pressure head created by the rotation of inner fan blades 185). In the embodiment shown, the width of middle ring 186 is such that, when fan system 180 is connected to a portion of the shaft of rotor body 110, the back edge of middle ring 186 is close to (e.g., within a few inches of) the ends of the rotor field windings (e.g., first winding 122 and second winding 124). As a result, the rotation of rotor body 110 (and consequently fan system 180) will create (a) gas flow moving toward the ends of the rotor field windings and through the openings in the openings braces positioned between them (e.g., openings brace 100) due specifically to the rotation of outer fan blades 188, and (b) gas flow moving toward and through the rotor body cooling ducts (not visible in FIG. 22) due specifically to the rotation of inner fan blades 185, and those two gas flows will be substantially separate from each other. By keeping them separate, cooling of the rotor field windings may be more efficient (less wasted air flow) and effective. Middle ring 186 may also be characterized as a flow separator that is configured to substantially separate the flow created by the outer fan blades (e.g., external flow) from the flow created by the inner fan blades (e.g., internal flow) such that the external and internal flows are substantially separated from each other when gas from the external flow reaches any rotor body cooling ducts.

FIG. 20 depicts arrows 198 showing an example of such external flow and the results of such external flow and arrows 165, 161, 163 and 167 showing an example of such internal flow and the results of such internal flow (the fan system is not shown).

FIG. 19 is an end view of an embodiment of rotor assembly 120, where fan system 180 connected to rotor body 110. In this embodiment, the center of fan system 180 is rotation axis 113. As this figure shows, inner fan blades 185 may be positioned (e.g., configured) so as to deliver cooling gas, when the fan system is operated, to the rotor body cooling ducts of certain of the present apparatuses. Further, as this figure shows, outer fan blades 188 may be positioned so as deliver cooling gas, when the fan system is operated, to the openings in the openings braces that are utilized. A fan system 180 may be positioned at each end of a rotor body, and the pitches of the various blades adjusted so that air is pushed in one direction at one end and pulled in the same direction at the other end.

For a given version of fan system 190, the number of inner and outer fan blades used, the pitch of each, and the size of each will depend on the flow resistance that will be encountered. That flow resistance will depend on a number of factors, such as the size of openings 40 in openings braces 100, the spacing of those braces, the size of the rotor body cooling ducts that are used, and the resistance that will result from the stator. Those of ordinary skill in the art will understand, based on this disclosure, how to construct a suitable fan system based on such factors.

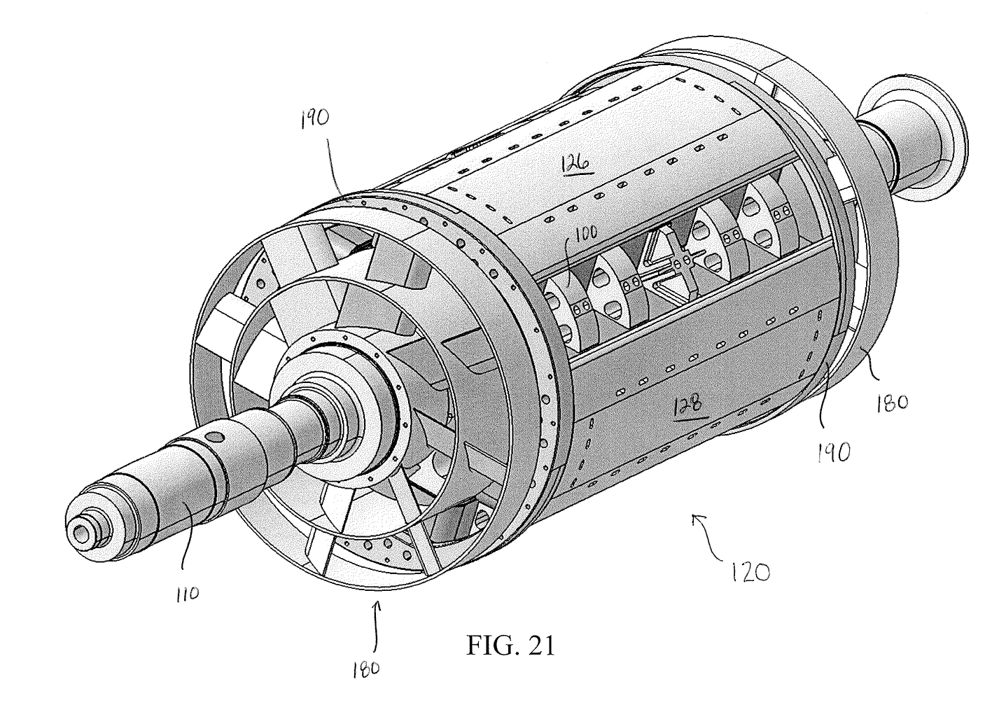

The present openings braces, the present blade braces, the present pole body cooling ducts, the present rotor body cooling ducts, and the present fan systems each may be used individually to cool the windings of rotor assemblies. Furthermore, these items also may be used in any combination with each other for the same purpose. FIG. 21 shows an embodiment of rotor assembly 120 in which all of the present apparatuses are utilized together.

Embodiments of the present apparatuses are configured to be part of a motor or generator capable of operating at least 1,500 revolutions per minute. Other, and in some cases the same, embodiments of the present apparatuses are configured to be part of a synchronous motor or generator capable of at least 1,000 horsepower. Embodiments of the present apparatuses also are configured to be part of a generator capable of generating at least 750 watts.

It should be understood that the present apparatuses are not intended to be limited to the particular forms disclosed. Rather, they are to cover all modifications, equivalents, and alternatives falling within the scope of the claims. For example, although 4-pole rotor assemblies have been depicted in certain figures, any of the present apparatuses are equally useful with rotor assemblies having more fewer or more poles than 4 (e.g., rotor assemblies having 2, 6, 8, 10, or more poles). Furthermore, the claims are not to be interpreted as including means-plus- or step-plus-function limitations, unless such a limitation is explicitly recited in a given claim using the phrase(s) “means for” or “step for,” respectively.

I claim:

1.-23. (canceled)

24. An apparatus comprising:
a rotor assembly that includes:
a rotor body having a rotation axis;
a non-laminated pole body extending from the rotor body, the non-laminated pole body having a first side in which a recess is positioned; and
a winding positioned around the non-laminated pole body;
where a pole body cooling duct is formed by at least the recess and the winding.

25. The apparatus of claim 24, where the pole body cooling duct is not gas-tight.

26. The apparatus of claim 24, further comprising a pole tip connected to the non-laminated pole body, the pole tip having a passageway in fluid communication with the pole body cooling duct.

27. The apparatus of claim 26, where the passageway is substantially perpendicular to the rotation axis.

28. The apparatus of claim 27, where the rotor body includes a rotor body cooling duct in fluid communication with the pole body cooling duct.

29.-30. (canceled)

31. The apparatus of claim 28, where the first side of the non-laminated pole body includes multiple recesses, a pole body cooling duct is defined by at least each recess and the winding, and each pole body cooling duct is in fluid communication with the rotor body cooling duct.

32. (canceled)

33. The apparatus of claim 31, where the pole tip includes multiple passageways, and each passageway is in fluid communication with a pole body cooling duct.

34. The apparatus of claim 33, where the rotor body includes multiple rotor body cooling ducts, and each rotor body cooling duct is substantially parallel to the rotation axis.

35. The apparatus of claim 34, where the non-laminated pole body includes a second side, multiple recesses are positioned in both the first and second sides, a pole body cooling duct is defined by at least each recess and the winding, and each pole body cooling duct is in fluid communication with a rotor body cooling duct.

36.-38. (canceled)

39. An apparatus comprising:
a rotor assembly that includes:
a rotor body having a rotation axis;
a pole body extending from the rotor body, the pole body having a first side in which a recess is positioned, the first side being substantially parallel to the rotation axis; and
a winding positioned around the pole body;
where a pole body cooling duct is formed by at least the recess and the winding.

40. The apparatus of claim 39, further comprising a pole tip connected to the pole body, the pole tip having a passageway in fluid communication with the cooling duct.

41. The apparatus of claim 40, where the passageway is substantially perpendicular to the rotation axis.

42. The apparatus of claim 41, where the rotor body includes a rotor body cooling duct in fluid communication with the pole body cooling duct.

43.-44. (canceled)

45. The apparatus of claim 42, where the first side of the pole body includes multiple recesses, a pole body cooling duct is defined by at least each recess and the winding, and each pole body cooling duct is in fluid communication with the rotor body cooling duct.

46.-51. (canceled)

52. An apparatus comprising:
a rotor assembly that includes:
a rotor body having a rotation axis;
a non-laminated pole body extending from the rotor body, the non-laminated pole body having a first side that is substantially perpendicular to the rotation axis;
a winding positioned around the non-laminated pole body, the winding having a first end section that is substantially perpendicular to the rotation axis, the first end section having an inside, the inside and the first side of the non-laminated pole body bordering a space; and
a pole tip connected to the non-laminated pole body, the pole tip having a passageway in fluid communication with the space.

53. The apparatus of claim 52, where the passageway is substantially perpendicular to the rotation axis.

54. (canceled)

55. The apparatus of claim 52, where the rotor body includes a rotor body cooling duct.

56.-57. (canceled)

58. The apparatus of claim 52, where the pole tip includes multiple passageways, and each passageway is in fluid communication with the space.

59.-60. (canceled)

61. The apparatus of claim 52, where the non-laminated pole body has a second side that is substantially perpendicular to the rotation axis, the winding has a second end section that is substantially perpendicular to the rotation axis, the second end section has an inside, the inside of the second end section and the second side of the non-laminated pole body bordering a second space.

62.-68. (canceled)

69. An apparatus comprising:
rotor assembly A, rotor assembly B, or rotor assembly C, where rotor assembly A includes:
a rotor body having a rotation axis;
a non-laminated pole body extending from the rotor body, the non-laminated pole body having a first side in which a recess is positioned; and
a winding positioned around the non-laminated pole body;
where a pole body cooling duct is formed by at least the recess and the winding;
rotor assembly B includes:
a second rotor body having a rotation axis;
a first pole body extending from the second rotor body, the first pole body having a first pole body side in which a recess is positioned, the first pole body side being substantially parallel to the rotation axis of the second rotor body; and
a winding positioned around the first pole body;
where a pole body cooling duct is formed by at least the recess and the winding positioned around the first pole body; and
rotor assembly C includes:
a third rotor body having a rotation axis;
a second non-laminated pole body extending from the third rotor body, the second non-laminated pole body having a first side that is substantially perpendicular to the rotation axis of the third rotor body;
a first winding positioned around the second non-laminated pole body, the first winding having a first end section that is substantially perpendicular to the rotation axis of the third rotor body, the first end section having an inside, the inside and the first side of the first non-laminated pole body bordering a space; and
a pole tip connected to the first non-laminated pole body, the pole tip having a passageway in fluid communication with the space.

70.-72. (canceled)
